(19) United States
(12) Patent Application Publication
(10) Pub. No.: US 2010/0049492 A1
(43) Pub. Date: Feb. 25, 2010

(54) METHOD AND APPARATUS FOR MODELING SKIN SENSITIZATION

(75) Inventors: Seema Bajaria, New York, NY (US); Christina M. Friedrich, San Francisco, CA (US); Katherine Kudrycki, San Francisco, CA (US); Cameron Mackay, Milton Keynes (GB); Thomas Paterson, Redondo Beach, CA (US); Saroja Ramanujan, San Mateo, CA (US); Gregory Shaver, West Lafayette, IN (US)

Correspondence Address: ENTELOS, INC.;c/o Law Offices of Karen E. Flick, P.O. Box 515, El Granada, CA, 94018-0515, US

(73) Assignee: Entelos, Inc.

(21) Appl. No.: 12/441,050

(22) PCT Filed: Sep. 12, 2007
(86) PCT No.: PCT/US07/78325

§ 371 Date: Nov. 5, 2009

Related U.S. Application Data
(60) Provisional application No. 60/844,135, filed on Sep. 12, 2006.

(51) Int. Cl. G06G 7/48

(52) U.S. Cl. 703/11

(57) ABSTRACT

The invention encompasses novel computer models of chemical sensitivity of skin and systems for predicting chemical sensitivity of skin. In particular, the computer model of chemical sensitivity of skin comprises a) an epidermal compartment comprising a mathematical representation of exposure of an epidermal tissue to a chemical and a mathematical representation of a first population of antigen presenting cells interacting with the chemical; and b) a lymph node compartment comprising a mathematical representation of a second population of antigen presenting cells, and a mathematical representation of a population of T cells, wherein at least a subpopulation of the population of T cells interacts with the second population of antigen presenting cells.

### I. INTRODUCTION

A. Field of the Invention

The present invention relates generally to the field of simulating induction of skin sensitization upon exposure to a chemical.

B. Background of the Invention

Chemicals used in topically applied personal products have the potential to evoke allergic responses. The local lymph node assay (LLNA) is a standard approach for evaluating the ability of topically applied chemicals to induce skin sensitization and allergic dermatitis. In this assay, the lymph node (LN) proliferation resulting from topical application of chemicals is measured in mice as an indicator of chemical-driven sensitization induction. The sensitization induction is expressed as a stimulation index:

SI=[³H]thymidine_{veh+chem.}/[³H]thymidineᵥₑₕ

If the stimulation index is greater than 3, the chemical is positive for sensitization.

However, a European Union directive requires eventual elimination of animal testing for the development of personal and home products.

C. Summary of the Invention

One aspect of the invention provides computer models of chemical sensitivity of skin comprising (a) a computer-readable memory storing code to define an epidermal compartment and a lymph node compartment; and (b) a processor coupled to the computer-readable memory, the processor configured to process the code producing a simulated biological characteristic and to store the simulated biological characteristic in a computer-readable medium. The epidermal compartment comprises (1) a mathematical representation of exposure of an epidermal tissue to a chemical, and (2) a mathematical representation of a first population of antigen presenting cells interacting with the chemical; and the lymph node compartment comprises (1) a mathematical representation of a second population of antigen presenting cells; and (2) a mathematical representation of a population of T cells, wherein at least a subpopulation of the population of T cells interacts with the second population of antigen presenting cells. Preferably, the population of T cells comprises CD4+ and CD8+ cells. Preferably, the epidermal compartment further comprises a mathematical representation of a plurality of cytokines in the epidermal tissue. More preferably, the plurality of cytokines comprises at least one cytokine selected from the group consisting of IL-1α, IL-1β, IL-4, IL-8, IL-10, IL-18, TNF-α, GM-CSF, IFN-γ, and PGE2. Typically, the first population of antigen presenting cells comprises a population of Langerhans cells in the epidermal compartment and the second population of antigen presenting cells comprises a separate population of Langerhans cells in the lymph node compartment. In a preferred implementation, the computer model also comprises a representation of transit of antigen presenting cells from the epidermal compartment to the lymph node compartment. In another preferred implementation, the second population of antigen presenting cells comprises antigen presenting cells which were exposed to the chemical in the epidermal compartment and subsequently transited to the lymph node compartment. In certain implementations, the interaction between the chemical and the population of antigen presenting cells comprises uptake of the chemical by cells within the population. The interaction between the chemical and the population of antigen presenting cells further can comprise processing of the chemical as a hapten. In yet another implementation, the second population of antigen presenting cells expresses costimulatory molecules based upon cytokines present in the epidermal compartment.

One aspect of the invention provides methods for developing a model of a chemical sensitivity of skin of a mammal, said method comprising: (a) identifying one or more biological processes associated with exposure of a chemical to cells in an epidermal compartment; (b) identifying one or more biological processes associate with T cell proliferation in a lymph node compartment; (c) mathematically representing each biological process to generate one or more representations of a biological process associated with exposure of the chemical to cells in the epidermal compartment and one or more representations of a biological process associated with cell proliferation in the lymph node compartment; and (d) combining the representations of biological processes to form a model of chemical sensitivity of skin. The method may further comprise storing the model of chemical sensitivity in a computer readable medium. Preferably, mathematically representing a biological process comprises forming a first mathematical relation among variables associated with a first biological process from one or more of the biological processes; and forming a second mathematical relation among variables associated with the first biological process and a second biological process.

Another aspect of the invention provides systems for predicting sensitivity of skin of a subject to a chemical comprising a) a computer-executable data editor capable of accepting biological data describing the chemical; b) a computer-executable integrator, capable of executing a computer model of skin sensitization with the biological data to generate a prediction of the sensitivity of the skin of the subject; and c) a computer-executable report generator capable of reporting the predicted sensitivity of the skin of the subject to the chemical. The computer model comprises an epidermal compartment comprising a representation of exposure of an epidermal tissue to a chemical, and a representation of a first population of antigen presenting cells interacting with the chemical, and a lymph node compartment comprising a representation of a second population of antigen presenting cells, and a representation of a population of T cells, wherein at least a subpopulation of the population of T cells interacts with the second population of antigen presenting cells. In certain implementations, the computer-executable data editor further is capable of accepting a set of parameters describing a virtual patient. In a preferred implementation, the computer-executable integrator further is capable of executing the computer model with the set of parameters describing the subject.

Another aspect of the invention provides systems comprising: a) a processor including computer-readable instructions stored thereon that, upon execution by a processor, cause the processor to simulate induction of skin sensitivity; b) a first user terminal, the first user terminal operable to receive a user input specifying one or more parameters associated with one or more mathematical representations defined by the computer readable instructions; and c) a second user terminal, the second user terminal operable to provide the set of outputs to a second user. The computer readable instructions comprise i) mathematically representing one or more biological processes associated with exposure of a chemical to an antigen presenting cell in an epidermal compartment; ii) mathematically representing one or more biological processes associated with antigen presentation and/or T cell activation in a lymph node compartment; iii) defining a set of mathematical relationships between the representations of biological processes associated with the epidermal compartment and representations of biological processes associated with the lymph node compartment; and iv) applying a virtual protocol to the set of mathematical relationships to generate a set of outputs.

Yet another aspect of the invention provides systems comprising (a) a processor including computer-readable instructions stored thereon that, upon execution by a processor, cause the processor to simulate induction of chemical sensitivity of skin; (b) a first user terminal, the first user terminal operable to receive a user input specifying one or more parameters associated with one or more mathematical representations defined by the computer readable instructions; and (c) a second user terminal, the second user terminal operable to provide the set of outputs to a second user. The instructions comprise (i) mathematically representing one or more biological processes associated with an epidermal compartment; (ii) mathematically representing one or more biological processes associated with lymph node compartment (iii) defining a set of mathematical relationships between the representations of biological processes associated with the epidermal compartment and representations of biological processes associated with the lymph node compartment; and (iv) applying a virtual protocol to the set of mathematical relationships to generate a set of outputs. Preferably, the one or more biological processes associated with the epidermal compartment include exposure of an epidermal tissue to a chemical, a first population of antigen presenting cells and a plurality of cytokines expressed by cells in the epidermis. Preferably, the one or more biological processes associated with the lymph node compartment include a second population of antigen presenting cells and a population of T cells, wherein at least a subpopulation of the population of T cells interacts with the second population of antigen presenting cells.

One aspect of the invention provides computer models of antigen presentation comprising a) a costimulatory molecule regulation module comprising a representation of regulated expression of a plurality of costimulatory molecules by a population of antigen presenting cells in a first compartment, wherein the expression is regulated by a plurality of cytokines; b) a transit module comprising a representation of transit of the antigen presenting cells from the first compartment to a second compartment; and c) a T cell stimulation module comprising a representation of interaction between a population of antigen presenting cells and a population of T cells in the second compartment, whereby a subpopulation of the populations of T cells is selectively activated by the population of antigen presenting cells based on the expression of the plurality of costimulatory molecules. Preferably, the plurality of cytokines comprises at least one cytokine selected from the group consisting of IL-1α, IL-1β, IL-4, IL-8, IL-10, IL-18, TNF-α, GM-CSF, IFN-γ and PGE2. In a particularly preferred implementation, the plurality of cytokines comprises all of the cytokines in this group. In certain implementations of the invention, the population of antigen presenting cells is a population of dendritic cells. Preferably, the population of dendritic cells is a population of Langerhans cells. In a preferred implementation, the subpopulation of T cells is further activated by a plurality of cytokines expressed in the lymph node. Preferably, the plurality of costimulatory molecules comprises a molecule selected from the group consisting of MHC I, MHC II, B7-1, B7-2, an anti-apoptotic molecule and IL-12. The anti-apoptotic molecule can include, but is not limited to OX40L, 4-1BBL or CD70. In a preferred implementation, the plurality of cytokines regulate costimulatory molecule expression when the population of antigen presenting cells uptake an antigen. In certain implementations, the first compartment is a peripheral tissue and the second compartment is a lymph node. Preferably, the peripheral tissue is epidermal tissue. In another preferred implementation, the subpopulation of T cells is a population of CD8+ T cells. Preferably, the population of CD8+ T cells is selectively activated by expression of cytokines and costimulatory molecules. In an alternate preferred implementation, the subpopulation of T cells is a population of CD4+ T cells. Preferably, the population of CD4+ T cells is selectively activated by expression of cytokines and costimulatory molecules.

It will be appreciated by one of skill in the art that the embodiments summarized above may be used together in any suitable combination to generate additional embodiments not expressly recited above, and that such embodiments are considered to be part of the present invention.

### II. BRIEF DESCRIPTION OF THE DRAWINGS

An overview of the methods used to develop computer models of skin sensitivity is illustrated in FIG. 1.

FIG. 2 provides a diagrammatic summary of an exemplary model of induction of chemical sensitivity of skin.

FIG. 3 illustrates an exemplary Summary Diagram that links modules for costimulatory molecule express, T cell stimulation and other related biological processes.

FIG. 4 illustrates an example of an Effect Diagram, in which cytokine production in the epidermis is described.

FIG. 5 provides an effect diagram describing various aspects of epidermal cell dynamics.

FIG. 6 provides an effect diagram describing certain aspects of chemical exposure of skin.

FIG. 7 provides an effect diagram illustrating chemical interaction in the epidermis, which can be influenced by the density of Langerhans cells at various stages of maturation, mast cell density, keratinocytes cell density and T cell density.

FIG. 8 provides an effect diagram illustrating the dynamics of Langerhans cells within both the epidermal compartment and the lymph node compartment.

FIG. 9 provides an effect diagram of the costimulatory molecule module.

FIGS. 10A, 10B and 10C provide effect diagrams illustrating various lymph node calculations that can be used in conjunction with computer models of the invention.

FIGS. 11 and 12 provide effect diagrams the life cycle of CD4+ T cells and CD8+ T cells, respectively.

FIGS. 13 and 14 provide effect diagrams of the T cell stimulation module, in which costimulatory molecules expressed by the antigen presenting cells influence the selective activation and proliferation of CD4+ or CD8+ T cells.

FIGS. 15A and 15B provide effect diagrams illustrating the regulation of cytokine production and receptor expression by T cells.

FIGS. 16A and 16B provide effect diagrams describing the division dynamics of the CD4+ and CD8+ T cell populations, respectively.

FIGS. 17A and 17B provide effect diagrams illustrating the parallel CD4+ T cell life cycle and division dynamics useful for calculating the average number of divisions of CD4+ T cells in the context of the computer models.

FIGS. 18A and 18B provide effect diagrams illustrating the parallel CD8+ T cell life cycle and division dynamics useful for calculating the average number of divisions of CD8+ T cells in the context of the computer models.

FIG. 19 provides an effect diagram describing a virtual local lymph node assay.

FIG. 20 provides a schematic illustration of antigen presentation, T cell activation in the lymph node, and subsequent T cell clonal expansion.

FIG. 21 demonstrates that LLNA stimulation index (SI) dose-response is strongly influenced by varying either (a) chemical antigenicity or (b) the number of responding T cell clones. Analysis is based on variation around DNCB.

FIG. 22 illustrates LLNA stimulation index (SI) dose-responses simulated for three prototypical chemicals and three known chemicals: (a) prototypical non/weak sensitizer, (b) prototypical moderate sensitizer, (c) prototypical strong sensitizer, (d) sodium lauryl sulfate (SLS), (e) cinnamic aldehyde, (f) DNCB.

### III. DETAILED DESCRIPTION

### A. Overview

The invention encompasses novel computer models of chemical sensitivity of skin and systems for predicting chemical sensitivity of skin. In particular, the computer model of chemical sensitivity of skin comprises a) an epidermal compartment comprising a mathematical representation of exposure of an epidermal tissue to a chemical and a mathematical representation of a first population of antigen presenting cells interacting with the chemical; and b) a lymph node compartment comprising a mathematical representation of a second population of antigen presenting cells, and a mathematical representation of a population of T cells, wherein at least a subpopulation of the population of T cells interacts with the second population of antigen presenting cells.

### B. Definitions

A “biological system” can include, for example, an individual cell, a collection of cells such as a cell culture, an organ, a tissue, a multi-cellular organism such as an individual human patient, a subset of cells of a multi-cellular organism, or a population of multi-cellular organisms such as a group of human patients or the general human population as a whole. A biological system can also include, for example, a multi-tissue system such as the nervous system, immune system, or cardio-vascular system.

The term “biological component” refers to a portion of a biological system. A biological component that is part of a biological system can include, for example, an extra-cellular constituent, a cellular constituent, an intra-cellular constituent, or a combination of them. Examples of suitable biological components, include, but are not limited to, metabolites, DNA, RNA, proteins, surface and intracellular receptors, enzymes, hormones, cells, organs, tissues, portions of cells, tissues, or organs, subcellular organelles, chemically reactive molecules like H⁺, superoxides, ATP, as well as, combinations or aggregate representations of these types of biological variables. In addition, biological components can include chemical agents such as 2,4-dintirochlorobenzene (DNCB), oxazalone, hydroquinone, cinnamic aldehyde, isoeugenol, and glycerol.

The term “biological process” is used herein to mean an interaction or series of interactions between biological components. Examples of suitable biological processes, include, but are not limited to, activation, apoptosis or recruitment of certain cells (such as Langerhans cells), inflammation, cytokine production, and the like. The term “biological process” can also include a process comprising one or more chemical or therapeutic agents, for example the process of binding a chemical to an antigen presenting cell. Each biological variable of the biological process can be influenced, for example, by at least one other biological variable in the biological process by some biological mechanism, which need not be specified or even understood.

The term “parameter” is used herein to mean a value that characterizes the interaction between two or more biological components. Examples of parameters include affinity constants, Kₘ, K_{d}, k_{cat}, half life, or net flux of cells, such as T cells or Langerhans cells, into particular tissues.

The term “variable,” as used herein refers to a value that characterizes a biological component. Examples of variables include the total number of Langerhans cells, the number of active or inactive T cells, and the concentration of a cytokine, such as IL-10, TNF-α or IFN-γ.

The term “phenotype” is used herein to mean the result of the occurrence of a series of biological processes. As the biological processes change relative to each other, the phenotype also undergoes changes. One measurement of a phenotype is the level of activity of variables, parameters, and/or biological processes at a specified time and under specified experimental or environmental conditions.

A phenotype can include, for example, the state of an individual cell, an organ, a tissue, and/or a multi-cellular organism. Organisms useful in the methods and models disclosed herein include animals. The term “animal” as used herein includes mammals, such as humans. A phenotype can also include, but is not limited to, behavior of the system as a whole, e.g. induction of skin sensitization as measured by T cell activation and proliferation in a local lymph node. The conditions defined by a phenotype can be imposed experimentally, or can be conditions present in a patient type. For example, a non-sensitized skin phenotype can include a certain amount of inflammatory cytokines and number of activated and proliferating T cells in a lymph node. In another example, a sensitized skin phenotype can include increased amounts of inflammatory cytokines and increased numbers of activated and proliferating T cells in a local lymph node. In yet another example, the phenotype can include the amounts of proliferating T cells for a patient being treated with one or more of the therapeutic agents.

The term “simulation” is used herein to mean the numerical or analytical integration of a mathematical model. For example, simulation can mean the numerical integration of the mathematical model of the phenotype defined by the equation, i.e., dx/dt=f(x, p, t).

The term “biological characteristic” is used herein to refer to a trait, quality, or property of a particular phenotype of a biological system. For example, biological characteristics of skin sensitive to a chemical include clinical signs and diagnostic criteria associated with the sensitized skin. The biological characteristics of a biological system can be measurements of biological variables, parameters, and/or processes. Suitable examples of biological characteristics associated with sensitized skin include, but are not limited to, measurements of total lymph node cellularity, amount and activation of T cells, and concentration of certain inflammatory cytokines.

The term “computer-readable medium” is used herein to include any medium which is capable of storing or encoding a sequence of instructions for performing the methods described herein and can include, but are not limited to, optical and/or magnetic storage devices and/or disks, and carrier wave signals.

### C. Methods of Developing Models of Chemical Sensitivity of Skin

The present invention provides a mathematical model of skin sensitization and the LLNA as part of an integrated in silico/experimental approach to the assessment of chemical sensitization risk The exemplified computer model of skin sensitization induction is a large-scale nonlinear ordinary differential equation-based representation of the key biological mechanisms involved in the induction phase of skin sensitization. The computer model is capable of simulating the following sequence of events: (1) chemical exposure in the epidermis; (2) epidermal cell activation and cytokine production; (3) chemical uptake and processing by epidermal Langerhans cells (LCs); (4) LC traffic to the draining LN; (5) antigen presentation and costimulation in the LN, and (6) the resulting CD4+ and CD8+ T cell responses. The computer model was calibrated using a range of in vitro and in vivo animal and human data available in the public domain. The ability of the computer model to reproduce the observed responses to a range of chemicals was used as independent validation.

A computer model can be designed to model one or more biological processes or functions. The computer model can be built using a “top-down” approach that begins by defining a general set of behaviors indicative of a biological condition, e.g. induction of skin sensitivity in response to a chemical. The behaviors are then used as constraints on the system and a set of nested subsystems are developed to define the next level of underlying detail. For example, given a behavior such as inflammation of skin, the specific mechanisms inducing the behavior can each be modeled in turn, yielding a set of subsystems, which can themselves be deconstructed and modeled in detail. The control and context of these subsystems is, therefore, already defined by the behaviors that characterize the dynamics of the system as a whole. The deconstruction process continues modeling more and more biology, from the top down, until there is enough detail to replicate a given biological behavior.

The methods used to develop computer models of skin sensitization typically begin by identifying one or more biological processes associated with an epidermal compartment and one or more biological processes associated with a lymph node compartment. The identification of biological processes associated with epidermal or lymph node compartment can be informed by data relating to the epidermis or immune system or any portion thereof. Optionally, the method can also comprise the step of identifying one or biological processes associated with transit of antigen presenting cells from the epidermal compartment to the lymph node compartment. The method next comprises the step of mathematically representing each identified biological process. The biological processes can be mathematically represented in any of a variety of manners. Typically, the biological process is defined by the equation, i.e., dx/dt=f(x, p, t), as described below. The representations of biological processes associated with epidermal and lymph node compartments are combined, thus forming predictive models of skin sensitization. An overview of the methods used to develop computer models of skin sensitivity is illustrated in FIG. 1.

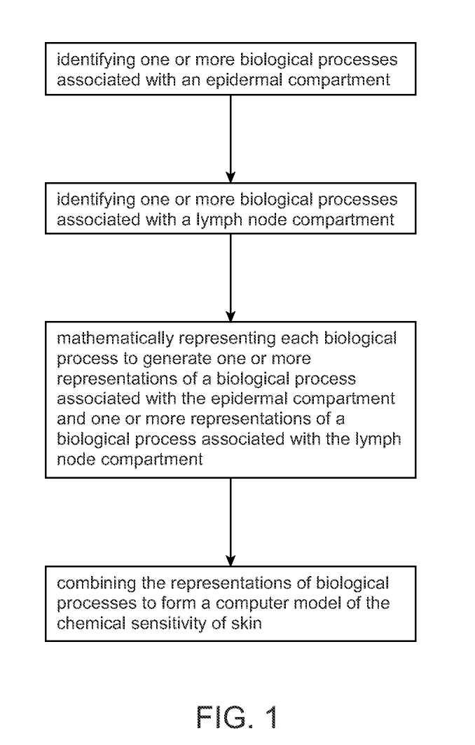

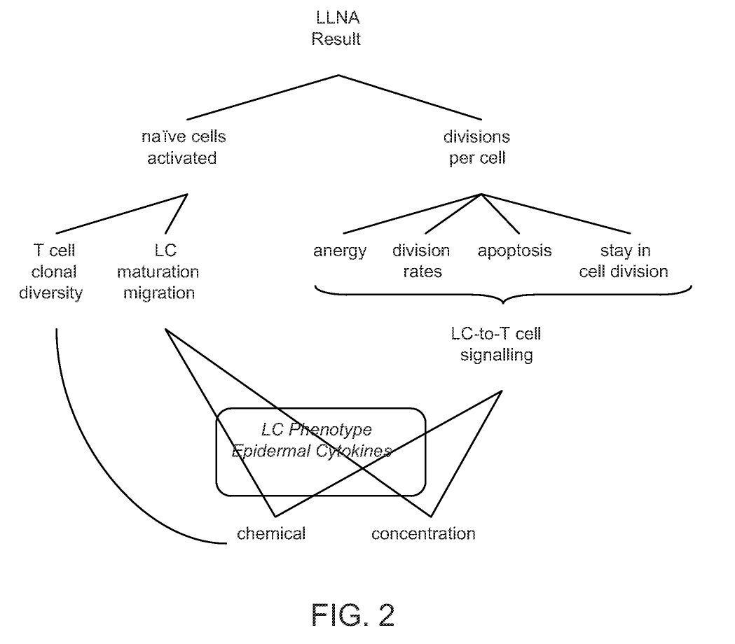

FIG. 2 illustrates various biological processes associated with chemical sensitivity of the skin. In one implementation of the invention, a primary measure of induction of skin sensitivity is a simulation of the standard local lymph node assay (LLNA). The LLNA is a measure of T cell stimulation in a lymph node. The activation and proliferation of T cells, in turn, is responsive to antigen presenting cells that encountered a chemical in the epidermis. Therefore, two biological compartments are represented in the models of the present invention: an epidermal compartment and a lymph node compartment. Whether skin sensitivity to a chemical occurs is dynamically responsive to changing conditions in both compartments.

In a preferred implementation of the invention, identifying a biological process associated with an epidermal compartment comprises identifying a biological process related to exposure of an epidermal tissue to a chemical and identifying a biological process related to a population of antigen presenting cells interacting with the chemical in the epidermis. The biological process related to exposure of an epidermal tissue to a chemical can comprise the effect of the chemical on epidermal cell dynamics and resulting production of certain cytokines. The biological process related to a population of antigen presenting cells interacting with the chemical can comprise expression of certain costimulatory molecules in response to the cytokine milieu in the epidermis and/or uptake and presentation of the chemical as an immunogenic hapten.

In another preferred implementation of the invention, identifying a biological process associated with a lymph node compartment comprises identifying a biological process related to a population of antigen presenting cells in the lymph node and identifying a biological process relating to a population of T cells. The biological process related to a population of antigen presenting cells in a lymph node can comprise the expression of certain cytokines by the antigen presenting cell and cell surface expression of certain costimulatory molecules as well as presentation of the chemical hapten to T cells. The biological process related to a population of T cells can comprise interaction between the T cells and the antigen presenting cells as well as activation or proliferation of the T cells in response to this interaction.

Once one or more biological processes are identified in the context of the methods of the invention, each biological process is mathematically represented. For example, the computer model can represent a first biological process using a first mathematical relation and a second biological process using a second mathematical relation. A mathematical relation typically includes one or more variables, the behavior (e.g., time evolution) of which can be simulated by the computer model. More particularly, mathematical relations of the computer model can define interactions among variables describing levels or activities of various biological components of the biological system as well as levels or activities of combinations or aggregate representations of the various biological components. In addition, variables can represent various stimuli that can be applied to the physiological system. The mathematical model(s) of the computer-executable software code represents the dynamic biological processes related to induction of skin sensitization. The form of the mathematical equations employed may include, for example, partial differential equations, stochastic differential equations, differential algebraic equations, difference equations, cellular automata, coupled maps, equations of networks of Boolean or fuzzy logical networks, etc.

In some implementations, the mathematical equations used in the model are ordinary differential equations of the form:

dx/dt=f(x,p,t)

where x is an N dimensional vector whose elements represent the biological variables of the system, t is time, dx/dt is the rate of change of x, p is an M dimensional set of system parameters, and f is a function that represents the complex interactions among biological variables. In one implementation, the parameters are used to represent intrinsic characteristics (e.g., genetic factors) as well as external characteristics (e.g., environmental factors) for a biological system.

In some implementations, the phenotype can be mathematically defined by the values of x and p at a given time. Once a phenotype of the model is mathematically specified, numerical integration of the above equation using a computer determines, for example, the time evolution of the biological variables x(t) and hence the evolution of the phenotype over time.

The representation of the biological processes are combined to generate a model of chemical sensitivity of the skin. Generation of models of biological systems are described, for example, in U.S. Pat. Nos. 5,657,255 and 5,808,918, entitled “Hierarchical Biological Modeling System and Method”; U.S. Pat. No. 5,914,891, entitled “System and Method for Simulating Operation of Biochemical Systems”; U.S. Pat. No. 5,930,154, entitled “Computer-based System and Methods for Information Storage, Modeling and Simulation of Complex Systems Organized in Discrete Compartments in Time and Space”; U.S. Pat. No. 6,051,029, entitled “Method of Generating a Display for a Dynamic Simulation Model Utilizing Node and Link Representations”; U.S. Pat. No. 6,069,629, entitled “Method of Providing Access to Object Parameters Within a Simulation Model”; U.S. Pat. No. 6,078,739, entitled “A Method of Managing Objects and Parameter Values Associated With the Objects Within a Simulation Model”; U.S. Pat. No. 6,539,347, entitled “Method of Generating a Display For a Dynamic Simulation Model Utilizing Node and Link Representations”; U.S. Pat. No. 6,983,237, entitled “Method and Apparatus for Conducting Linked Simulation Operations Utilizing a Computer-Based System Model”; and PCT publication WO 99/27443, entitled “A Method of Monitoring Values within a Simulation Model.”

The methods further can comprise methods for validating the computer models described herein. For example, the methods can include generating a simulated biological characteristic associated with skin or cells exposed to a chemical, and comparing the simulated biological characteristic with a corresponding reference biological characteristic measured after chemical exposure of skin. The result of this comparison in combination with known dynamic constraints may confirm some part of the model, or may point the user to a change of a mathematical relationship within the model, which improves the overall fidelity of the model. Methods for validating the various models described herein are taught in U.S. Patent Publication 2002-0193979, entitled “Apparatus And Method For Validating A Computer Model, and in U.S. Pat. No. 6,862,561, entitled “Method and Apparatus for Computer Modeling a Joint.”

Systems that can be used in validation of the model include, for example, those assaying epidermal induction, such as cytokine production by epidermal cell cultures, keratinocyte cell lines or ex vivo epidermis, those assaying Langerhans cell migration through ex vivo epidermal sheets or accumulation in lymph node suspension, those assaying Langerhans cell maturation, e.g. by measuring expression of MHC or costimulatory molecules in cell culture or transgenic animal models, those assaying T cell response, such as proliferation, anergy, apoptosis or cytokine production by T cell cultures or in transgenic animal models, and those assaying lymph node conditions, such as measuring cell proliferation, cytokine production, lymph node weight or cell population distributions within the lymph node.

2,4-dintirochlorobenzene (DNCB) is one of the best characterized sensitizers in the public literature, and thus is an appropriate chemical for use in the initial testing of model functionality. The model validation can confirm whether the system response includes an appropriate level of T cell proliferation in the lymph node compared to known LLNA data, which is indicative of induction of sensitization by DNCB. The effects of additional sensitizing substances can also be tested. As a comparison, the known effects of at least one non-sensitizing irritant, for example sodium lauryl sulfate, can be implemented. In this case, simulation of the system response should give no significant T cell proliferation response.

### D. Computer Models of Skin Sensitivity

The invention provides computer models of chemical sensitivity of skin comprising a) an epidermal compartment comprising a mathematical representation of chemical exposure in the epidermis and a mathematical representation of a first population of antigen presenting cells; and b) a lymph node compartment comprising a mathematical representation of a second population of antigen presenting cells and a mathematical representation of a population of T cells. Optionally, the computer model can also comprise one or more mathematical representations of a biological process associated with transit of antigen presenting cells from the epidermal compartment to the lymph node compartment. Preferably the model is stored in a computer readable memory as code defining each compartment and includes a processor configured to process the code producing a simulated biological characteristic and to store the simulated biological characteristic in a computer-readable medium

The model includes two tissue compartments, the epidermis of the skin and the draining lymph node, and the associated functions of antigen presenting cells, particularly Langerhans cells, and of T cells. The model preferably represents the production and release of inflammatory cytokines within the epidermis, the activation of Langerhans cells following penetration of a sensitizing chemical substance on the skin, the subsequent migration of Langerhans cells into the draining lymph node, antigen presentation by the Langerhans cells to T cells, and the resulting T cell activation and proliferation. In certain implementations, the model can be calibrated to represent a 1 cm² area of animal skin tissue, preferably human adult skin tissue located on the forearm.

The methods of developing models of skin sensitivity described above may be used to generate a model for simulating indication of skin sensitivity after exposure of the skin to a chemical. In such a case, the simulation model may include hundreds or even thousands of objects, each of which may be representative of a variable and include a number of parameters. In order to perform effective “what-if” analyses using a simulation model, it is useful to access and observe the input values of certain key parameters and variables prior to performance of a simulation operation, and also possibly to observe output values for these key parameters and variables at the conclusion of such an operation. As many parameters and variables are included in the expression of, and are affected by, a relationship between two objects, a modeler may also need to examine certain parameters and variables at either end of such a relationship. For example, a modeler may wish to examine parameters that specify the effects a specific object has on a number of other objects, and also parameters that specify the effects of these other objects upon the specific object. Complex models are also often broken down into a system of sub-models, either using software features or merely by the modeler's convention. It is accordingly often useful for the modeler simultaneously to view selected parameters and variables contained within a specific sub-model. The satisfaction of this need is complicated by the fact that the boundaries of a sub-model may not be mutually exclusive with respect to parameters, i.e., a single parameter may appear in many sub-models. Further, the boundaries of sub-models often change as the model evolves.

The created computer model represents biological processes at multiple levels and then evaluates the effect of the biological processes on biological processes across all levels. Thus, preferably, the created computer model provides a multi-variable view of a biological system. The created computer model also, preferably, provides cross-disciplinary observations through synthesis of information from two or more disciplines into a single computer model or through linking two computer models that represent different disciplines.

An exemplary computer model reflects a particular biological system, e.g., the epidermis and associated portions of the immune system, and anatomical factors relevant to issues to be explored by the computer model. The level of detail incorporated into the model is often dictated by a particular intended use of the computer model. For example, biological components being evaluated often operate at a subcellular level; therefore, the subcellular level can occupy the lowest level of detail represented in the model. The subcellular level includes, for example, biological components such as DNA, mRNA, proteins, chemically reactive molecules, and subcellular organelles. Similarly, the model can be evaluated at the multicellular level or even at the level of a whole organism. Because an individual biological system, e.g. a single human, is a common entity of interest with respect to the ultimate effect of the biological components, the individual biological system (e.g., represented in the form of clinical outcomes) is the highest level represented in the system. Chemical and therapeutic interventions are introduced into the model through changes in parameters at lower levels, with clinical outcomes being changed as a result of those lower level changes, as opposed to representing effects by directly changing the clinical outcome variables. Typically, the model represents evolving dynamics of cell populations, rather than the sequence of events for a single cell.

The level of detail reported to a user can vary depending on the level of sophistication of the target user. For a healthcare setting, especially for use by members of the public, it may be desirable to include a higher level of abstraction on top of a computer model. This higher level of abstraction can show, for example, major physiological subsystems and their interconnections, but need not report certain detailed elements of the computer model—at least not without the user explicitly deciding to view the detailed elements. This higher level of abstraction can provide a description of the virtual patient's phenotype and underlying physiological characteristics, but need not include certain parametric settings used to create that virtual patient in the computer model. When representing chemical exposure, this higher level of abstraction can describe what the chemical exposure does but need not include certain parametric settings used to simulate that exposure in the computer model. A subset of outputs of the computer model that is particularly relevant for subjects and doctors can be made readily accessible. In an alternative implementation, the output can comprise an identification of one or more biological processes that most significantly affect whether a particular chemical will or will not induce chemical sensitivity. In certain implementations, the output may suggest biological assays that can be used to assess the sensitizing potential of a chemical.

In a preferred implementation, the computer model is configured to allow visual representation of mathematical relations as well as interrelationships between variables, parameters, and biological processes. This visual representation includes multiple modules or functional areas that, when grouped together, represent a large complex model of a biological system.

In one implementation, simulation modeling software is used to provide a computer model, e.g., as described in U.S. Pat. No. 5,657,255, issued Aug. 12, 1997, titled “Hierarchical Biological Modeling System and Method”; U.S. Pat. No. 5,808,918, issued Sep. 15, 1998, titled “Hierarchical Biological Modeling System and Method”; U.S. Pat. No. 6,051,029, issued Apr. 18, 2000, titled “Method of Generating a Display for a Dynamic Simulation Model Utilizing Node and Link Representations”; U.S. Pat. No. 6,539,347, issued Mar. 25, 2003, titled “Method of Generating a Display For a Dynamic Simulation Model Utilizing Node and Link Representations”; U.S. Pat. No. 6,078,739, issued Jan. 25, 2000, titled “A Method of Managing Objects and Parameter Values Associated With the Objects Within a Simulation Model”; U.S. Pat. No. 6,069,629, issued May 30, 2000, titled “Method of Providing Access to Object Parameters Within a Simulation Model”; U.S. Pat. No. 6,983,237, entitled “Method and Apparatus for Conducting Linked Simulation Operations Utilizing a Computer-Based System Model”; and U.S. Patent Publication No. US 2002-0193979 A1, entitled “Apparatus and Method for Validating a Computer Model,” and published 19 Dec. 2002. An example of simulation modeling software is found in U.S. Pat. No. 6,078,739.

Various Diagrams can be used to illustrate the dynamic relationships among the elements of the model of skin sensitization. Examples of suitable diagrams include Effect and Summary Diagrams.

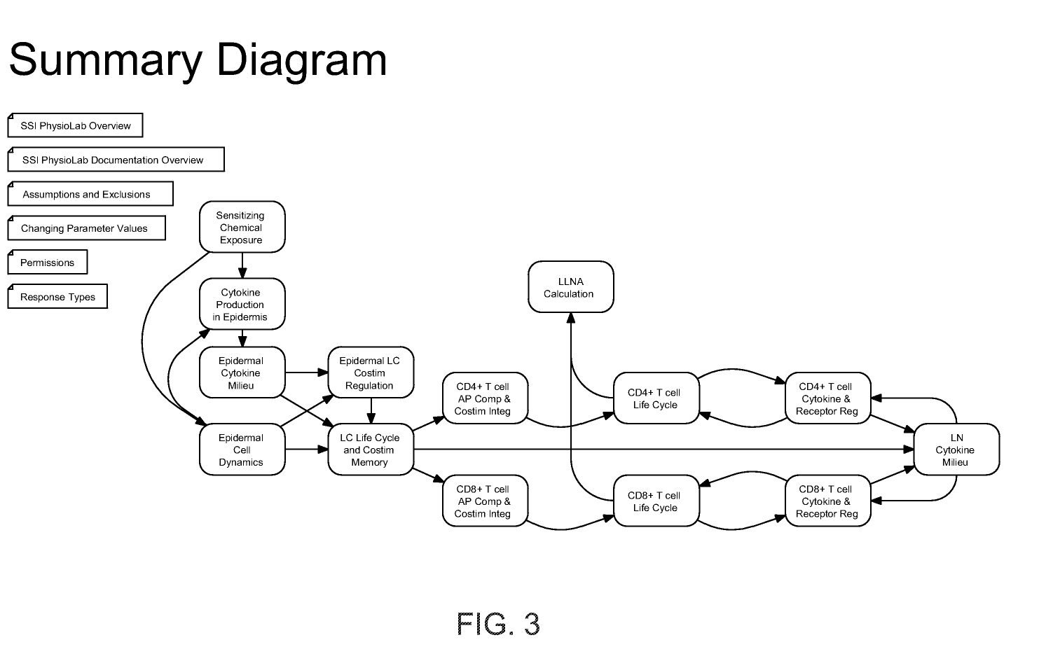

A Summary Diagram can provide an overview of the various pathways modeled in the methods and models described herein. For example, the Summary Diagram illustrated in FIG. 3 provides an overview of pathways that can affect induction of skin sensitization. The Summary Diagram can also provide links to individual modules of the model. The modules model the relevant components of the phenotype through the use of “state” and “function” nodes whose relations are defined through the use of diagrammatic arrow symbols. Thus, the complex and dynamic mathematical relationships for the various elements of the phenotype are easily represented in a user-friendly manner. In this manner, a normal phenotype can be represented.

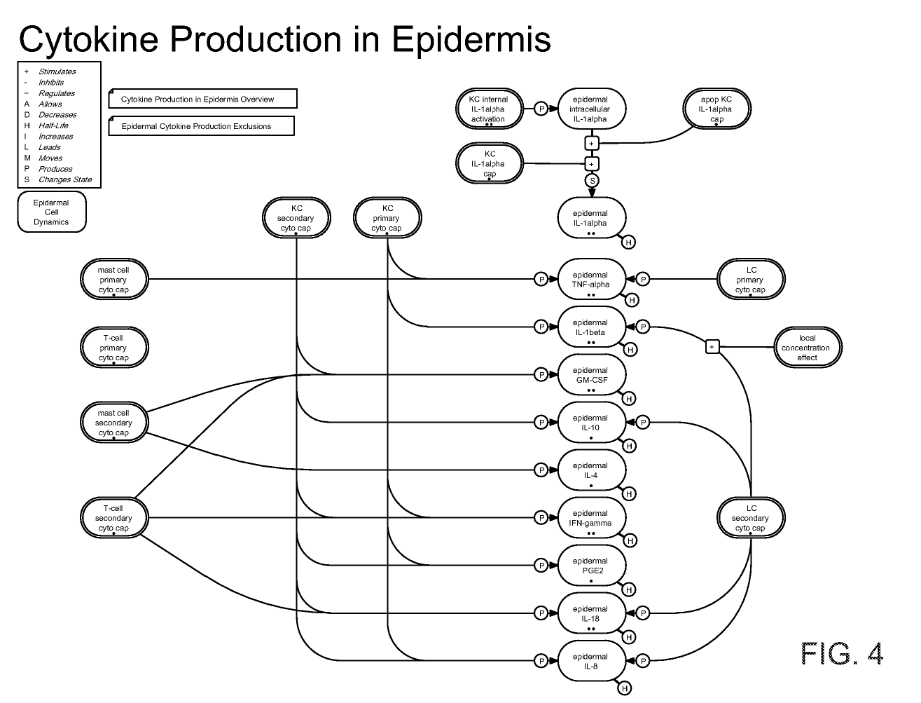

An Effect Diagram can be a visual representation of the model equations and illustrate the dynamic relationships among the elements of the model. FIG. 4 illustrates an example of an Effect Diagram, in which cytokine production in the epidermis is described. The Effect Diagram is organized into modules, or functional areas, which when grouped together represent the large complex physiology of the phenotype being modeled.

State and function nodes show the names of the variables they represent and their location in the model. The arrows and modifiers show the relationship of the state and function nodes to other nodes within the model. State and function nodes also contain the parameters and equations that are used to compute the values of the variables they represent in simulated experiments. In some embodiments, the state and function nodes are represented according to the method described in U.S. Pat. No. 6,051,029, entitled “Method of generating a Display for a Dynamic Simulation Model Utilizing Node and Link Representations,” incorporated herein by reference. Examples of state and function nodes are further discussed below.

State nodes are represented by single-border ovals and represent variables in the system, the values of which are determined by the cumulative effects of inputs over time. “Input” refers to any parameter or variable that can affect the variable being modeled by the state node. For example, input for a state node representing epidermal IL-1α can be epidermal intracellular IL-1α or IL-1α expression capacity of keratinocytes. State node values are defined by differential equations. The predefined parameters for a state node include its initial value (S₀) and its status. In some embodiments, state nodes can have a half-life. In these embodiments, a circle containing an “H” is attached to the node that has a half-life.

Function nodes are represented by double-border ovals and represent variables in the system, the values of which, at any point in time, are determined by inputs at the same point in time. Function nodes are defined by algebraic functions of their inputs. The predefined parameters for a function node include its value if locked (F₀) and its status. Setting the status of a node effects how the value of the node is determined. The status of a state or function node can be: 1) Computed, i.e., the value is calculated as a result of its inputs; 2) Specified-Locked, i.e., the value is held constant over time; or 3) Specified Data, i.e., the value varies with time according to predefined data points.

State and function nodes can appear more than once in the module diagram as alias nodes. Alias nodes are indicated by one or more dots (see, e.g., state node “epidermal IL-18” in FIG. 4). State and Function nodes are also defined by their position, with respect to arrows and other nodes, as being source nodes (S) and/or target nodes (T). Source nodes are located at the tails of arrows and target nodes are located at the heads of arrows. Nodes can be active or inactive.

Arrows link source nodes to target nodes and represent the mathematical relationship between the nodes. Arrows can be labeled with circles that indicate the activity of the arrow. A key to the annotations in the circles is located in the upper left corner of each effect Diagram. If an arrowhead is solid, the effect is positive. If the arrowhead is hollow, the effect is negative. For further description of arrow types, arrow characteristics, and arrow equations, see, e.g., U.S. Pat. No. 6,051,029, U.S. Pat. No. 6,069,629, U.S. Pat. No. 6,078,739, and U.S. Pat. No. 6,539,347.

FIG. 4 provides an effect diagram describing production of a plurality of cytokines in the epidermis. In a preferred embodiment, the computer model accounts for cytokines produced by one or more types of cells selected from keratinocytes, mast cells, Langerhans cells, and T cells. Preferably, the plurality of cytokines comprises at least one cytokine selected from the group consisting of IL-1α, IL-1β, IL-4, IL-8, IL-10, IL-18, TNF-α, GM-CSF, IFN-γ, and PGE2.

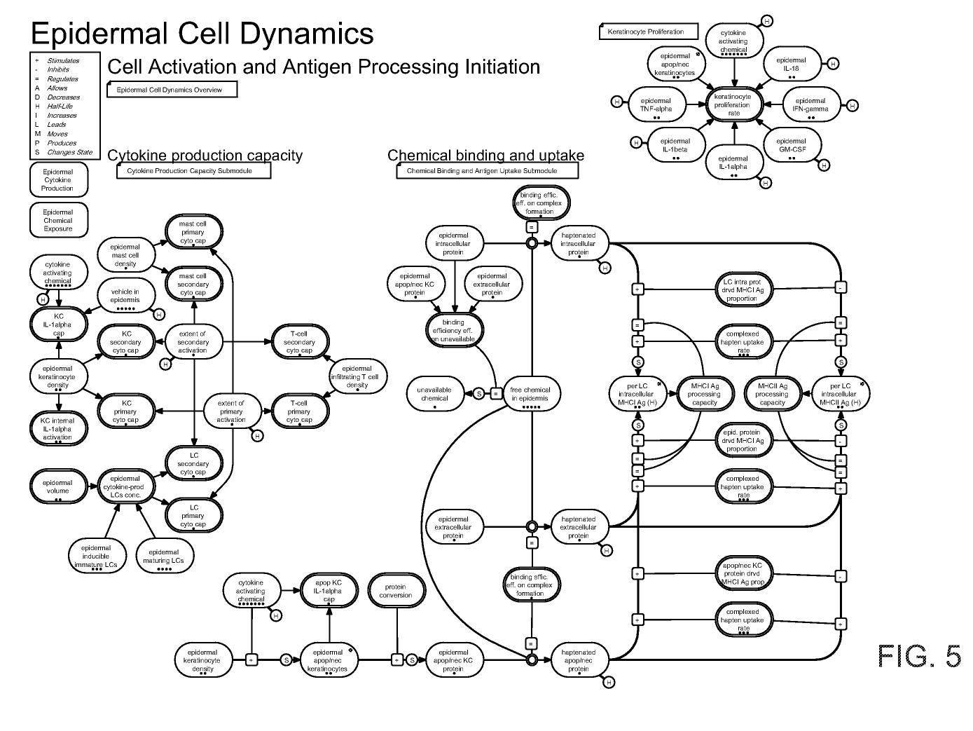

FIG. 5 provides an effect diagram describing various aspects of epidermal cell dynamics. The computer model can include a representation of one or more aspects of epidermal cell dynamics including keratinocyte proliferation, the cytokine-inducing effects of chemical exposure, and general cytokine production capacity. Keratinocytes represent approximately 90% of the nucleated cells present in the epidermis. These cells contribute to the inflammatory process by synthesizing and releasing various inflammatory cytokines (e.g., IL-1α, TNF-α) in response to irritants and sensitizing substances, as well as providing a basal level of these cytokines under homeostatic conditions. In certain implementations, the model represents the contribution of keratinocytes to sensitization by representing the secretion of soluble cytokines that influence Langerhans cells both basally and following epidermal penetration of a potentially sensitizing chemical. Discrete populations of keratinocytes with distinct biological functions, optionally, can be included to represent the various functions and differentiation states of the in vivo epidermis. The model can represent keratinocyte population dynamics, such as proliferation, apoptosis and differentiation. The model also can represent the expression of a representative set of cytokines, such as IL-1α and TNF-α, that regulate Langerhans cell activation and/or maturation. The population dynamics of keratinocytes can be explicitly represented in the model. Population dynamics preferable would include proliferation, differentiation and apoptosis of keratinocytes. Alternatively, the effects of the keratinocyte cell population can be modeled as the effect of the cytokine milieu of the epidermal compartment on Langerhans cells.

An important aspect of a model of induction of skin sensitization is the interaction between antigen presenting cells and the chemical or antigen. One aspect of the interaction is free chemical in the peripheral tissue, i.e. the epidermis. The interaction can also be influenced by the binding efficiency of the chemical, the amount of haptenated protein, and the amount of MHC I or MHC II expressed by the antigen presenting cells.

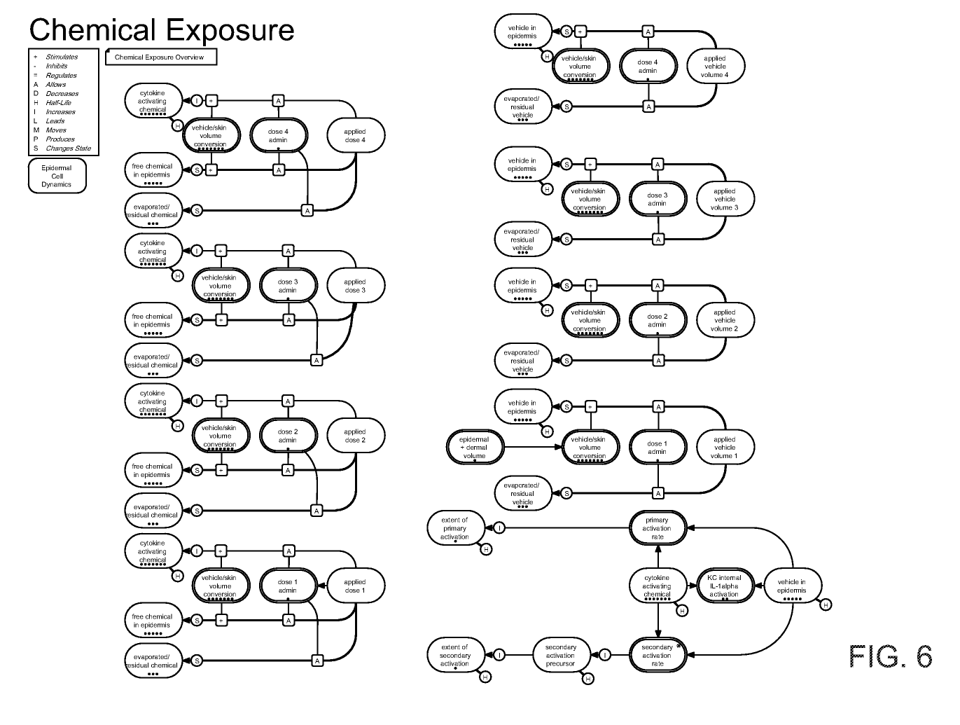

FIG. 6 provides an effect diagram describing certain aspects of chemical exposure of skin. In a preferred implementation, the computer model will include a representation of both the applied chemical as well as a vehicle used to apply the chemical to the skin. In one implementation of the computer model, a diffusion model determines free chemical/vehicle in epidermis and cytokine production based on applied chemical dose and exposure parameters. Because vehicle effects can contribute to cell activation and cytokine production, in a preferred implementation, vehicle effects are explicitly modeled. Accounting for vehicle effects allows smooth transition with increasing chemical dose and affects the denominator in SI calculation for a simulated LLNA. Free chemical binds to protein or becomes unavailable as specified by the “binding efficiency parameter.” In other implementations, the model can simulate application of more than one dose of the chemical and vehicle. Preferably the model can account for losses in the chemical due, for example, to evaporation.

In a preferred implementation of the invention, the computer model allows specification of relevant chemical properties giving rise to sensitization response. For example, in certain embodiments, the computer program provides explicit modeling of epidermal chemical exposure, epidermal cytokine induction in response to the chemical, the rate and amount of Langerhans cell antigen loading, and T cell responsiveness to the chemical antigen. In developing a model, preferably the chemical representation is formulated using known biological mechanisms, is constrained by biological feasibility and is constrained by known high-level behaviors, e.g., LLNA dose response.

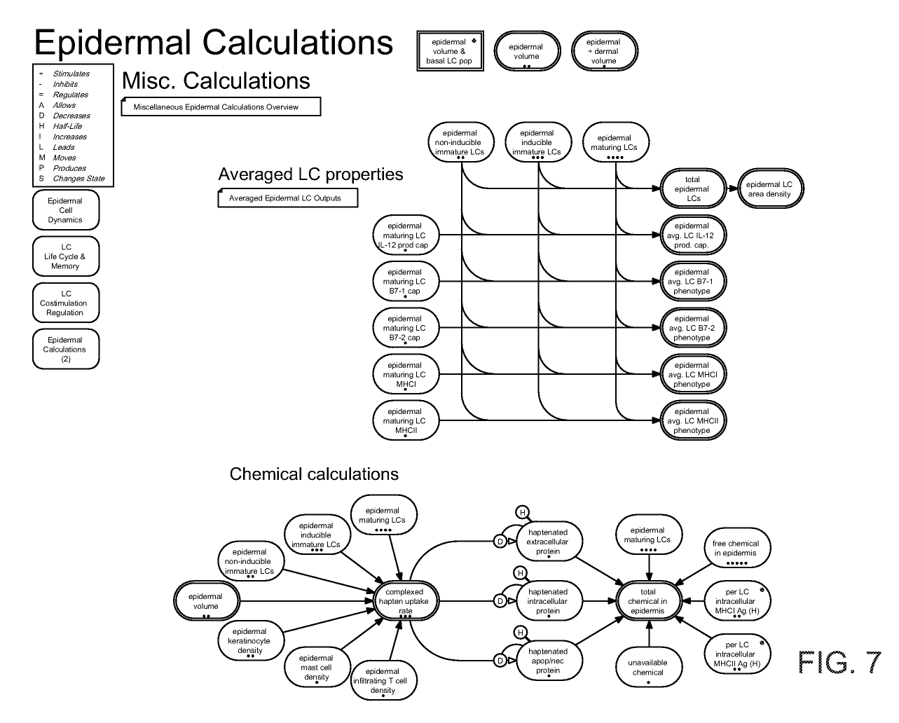

FIG. 7 provides an effect diagram illustrating chemical interaction in the epidermis, which can be influenced by the density of Langerhans cells at various stages of maturation, mast cell density, keratinocytes cell density and T cell density. The chemical is subject to uptake and being haptenated. However, not all chemical will be taken up into epidermal cells. Preferentially, the model will account for free chemical in the epidermis. FIG. 7 provides an effect diagram of an antigen presenting cell transit module, which in this implementation provides a representation of averaged properties of the Langerhans cells at the various stages of maturation.

Langerhans cells are immature dendritic cells resident in the epidermis whose primary function is to sample epidermal antigens and migrate to the draining lymph node following exposure to stimuli. En route to the draining lymph node, the Langerhans cells mature and acquire the antigen-presenting functionality of mature dendritic cells, which allows specific activation of naïve T cells and the initiation of a primary immune response. Antigen uptake, the presence of inflammatory cytokines such as IL-1β, and costimulation are implicated in the priming of Langerhans cells and their migration to the draining lymph node. Therefore, in certain implementations of the invention, the model can represent antigen uptake as a function of cytokine concentration and antigen level in the epidermal compartment. The antigen level may be soluble or cell-associated. In other implementations, the model can represent expression of surface molecules on Langerhans cells and/or antigen loading of Langerhans cells.

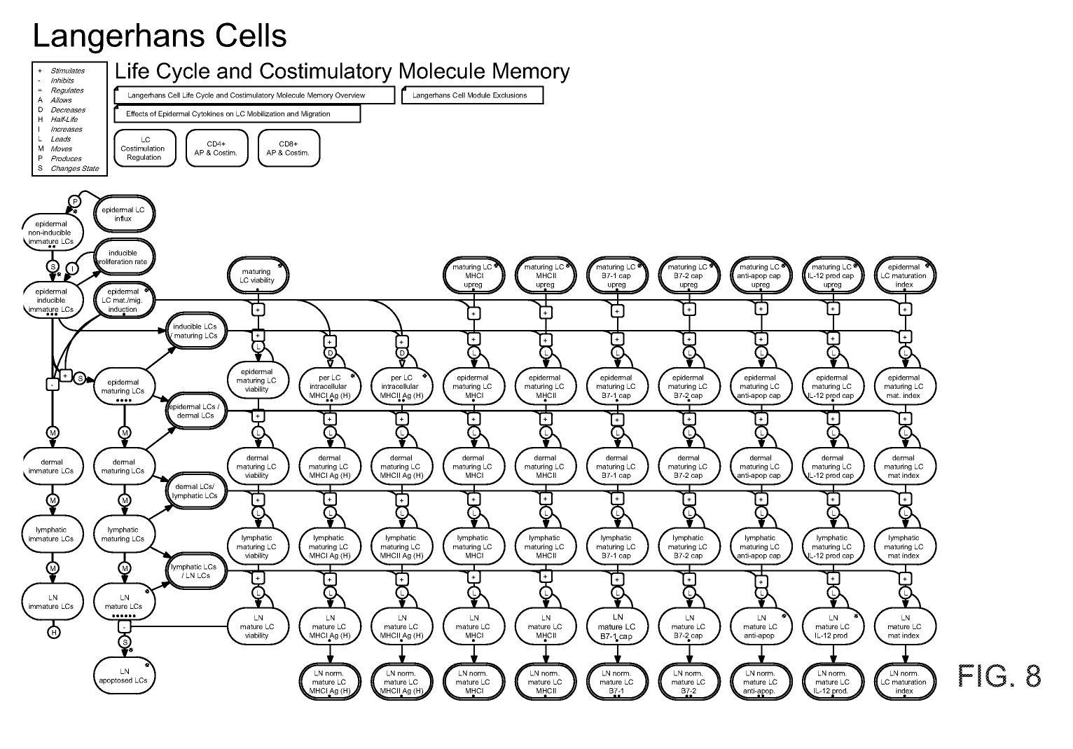

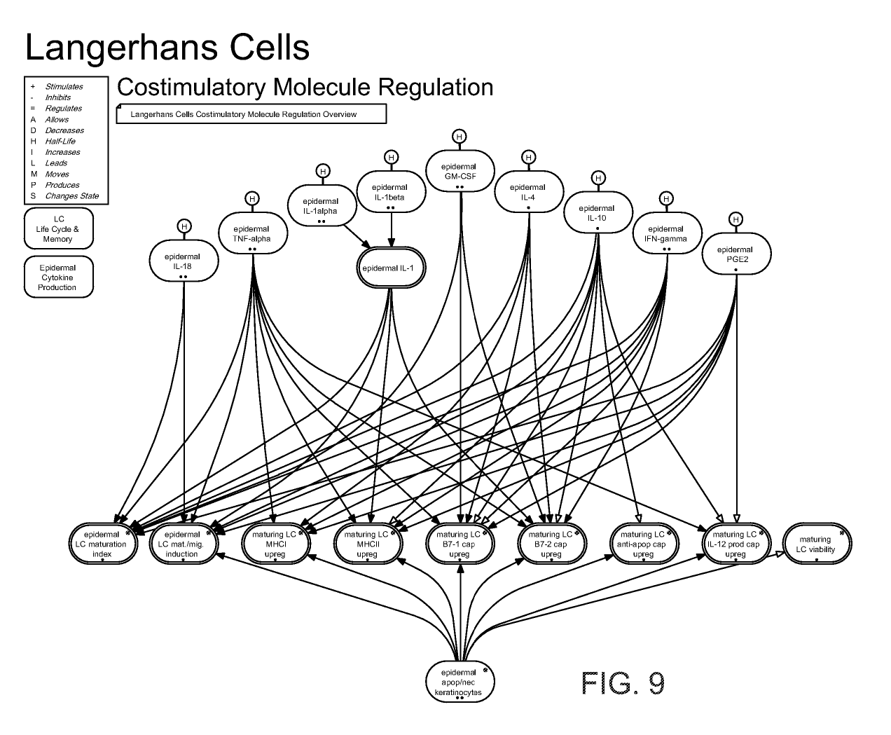

FIG. 8 provides an effect diagram illustrating the dynamics of Langerhans cells within both the epidermal compartment and the lymph node compartment. The Langerhans cells typically begin as immature dendritic cells infiltrating into the epidermis. The immature dendritic cells can be inducible or non-inducible. Once induced, the Langerhans cells begin maturing in the epidermal compartment. The maturing cells transit from the epidermis to the lymph node compartment. Once in the lymph node, the Langerhans cells mature and a certain subset will apoptose in that compartment. In the epidermal compartment, cells within the population of Langerhans cells will express, at varying rates, MHC I, MHC II, B7-1, B7-2, anti-apoptotic molecules and IL-12. IL-12 is produced by Langerhans cells and plays a role in initial activation and differentiation of T cells. The expression of each of these molecules is, typically, determined by the epidermal cytokine milieu as illustrated in the costimulatory molecule module (FIG. 9).

In a preferred implementation, the model represents Langerhans cell migration from the epidermal compartment to the lymph node compartment. The migration of these cells, optionally, can be regulated by surface molecule expression. The model also can represent production of cytokines, in the epidermal compartment or in the lymph node compartment, that regulate antigen presentation and/or T cell proliferation. In certain implementations, transit and maturation of the Langerhans cells enhances transit of T cells into the lymph node. This process in turn increases the number of activated CD4+ and CD8+ T cells in the lymph node.

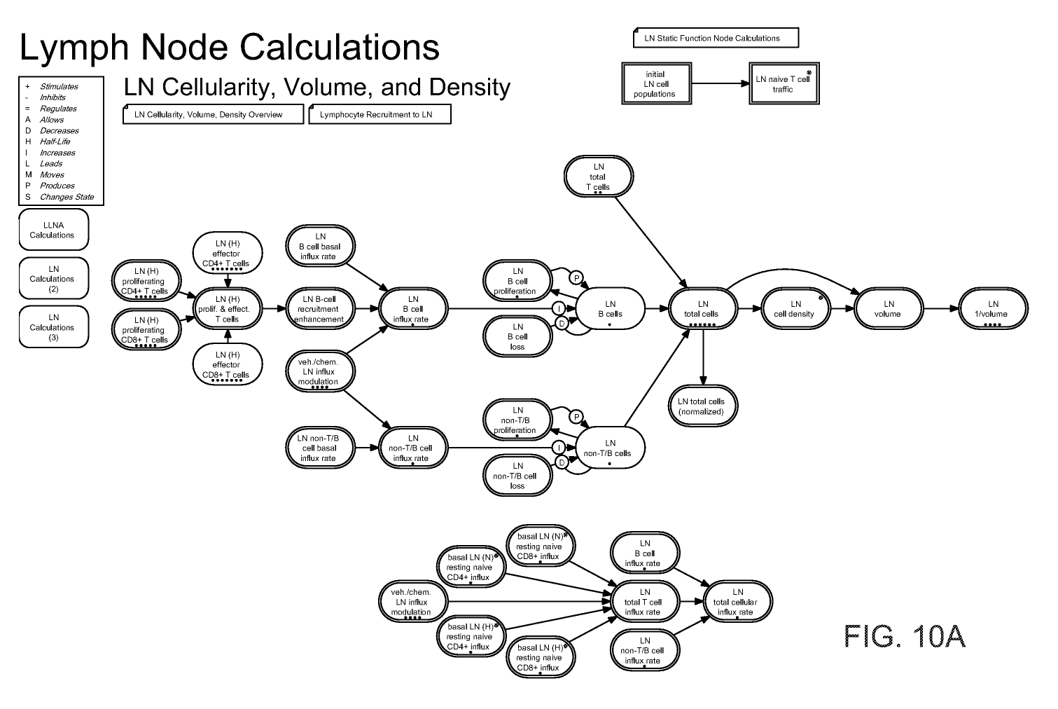

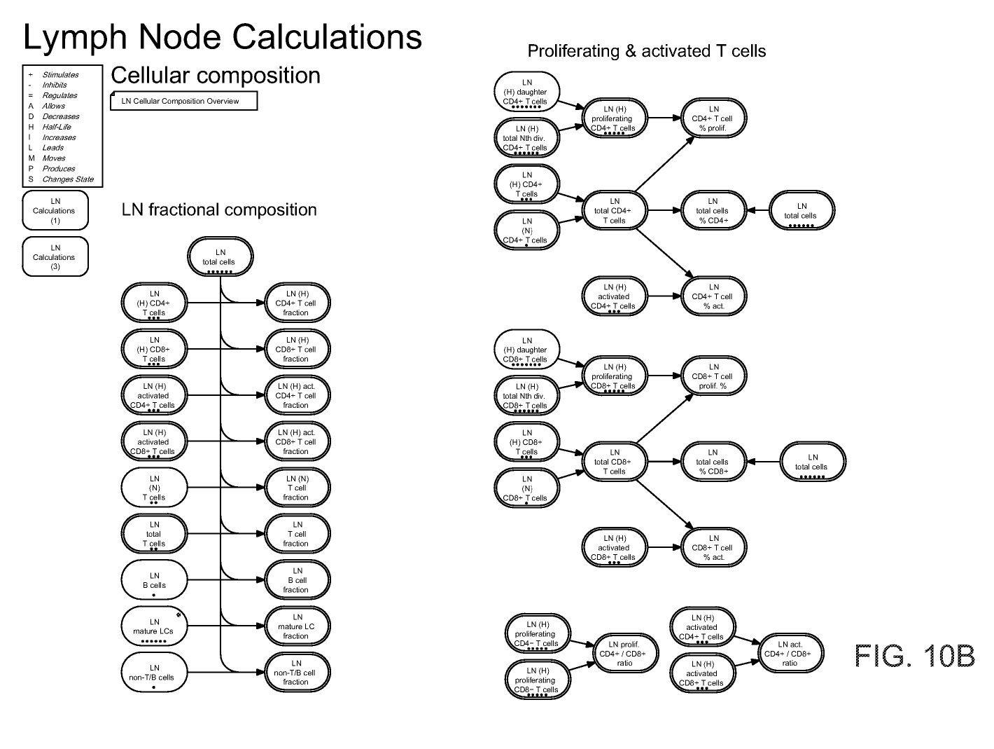

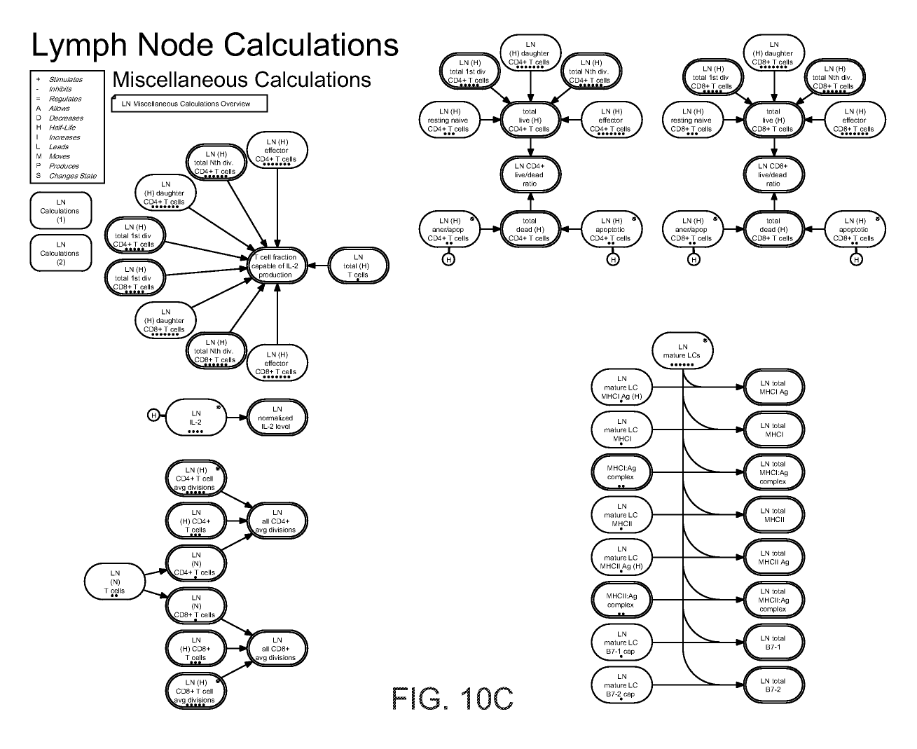

FIGS. 10A, 10B and 10C provide effect diagrams illustrating various lymph node calculations that can be used in conjunction with computer models of the invention. The lymph node, preferably, includes T cells, B cells and non-T/non-B cells. Further, the total number of cells within the lymph node will be a function of basal influx of cells into the lymph node plus any chemical induced influx and/or proliferation of immune cells in the lymph node.

T lymphocytes play a central role in cell-mediated allergic dermatitis. Following the contact of naïve CD4+ and CD8+ T cells with the sensitizing antigen presented by mature dendritic cells in the lymph node compartment, T cells begin to proliferate and differentiate. This leads to the establishment of effector and memory T cells that can react quickly to the hapten following subsequent contact. The level of dendritic cell maturation and the ratio of antigen-presenting cells to hapten-specific T cells are some of the determining factors for the level of T cell proliferation. In certain implementations, the model represents T cell priming, optionally as a function of antigen-loaded Langerhans cell numbers, CD4+ T cell numbers, surface molecule expression and/or soluble cytokines present in the lymph node compartment. The model also can represent T cell proliferation as modified by T cell priming, the proliferation rate and/or the apoptosis rate.

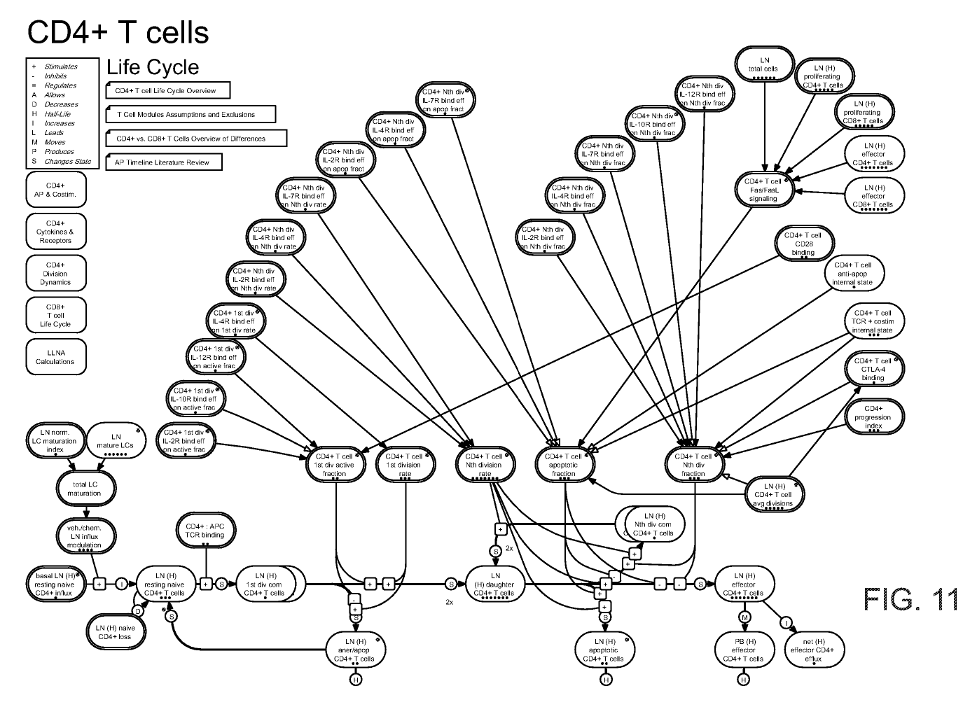

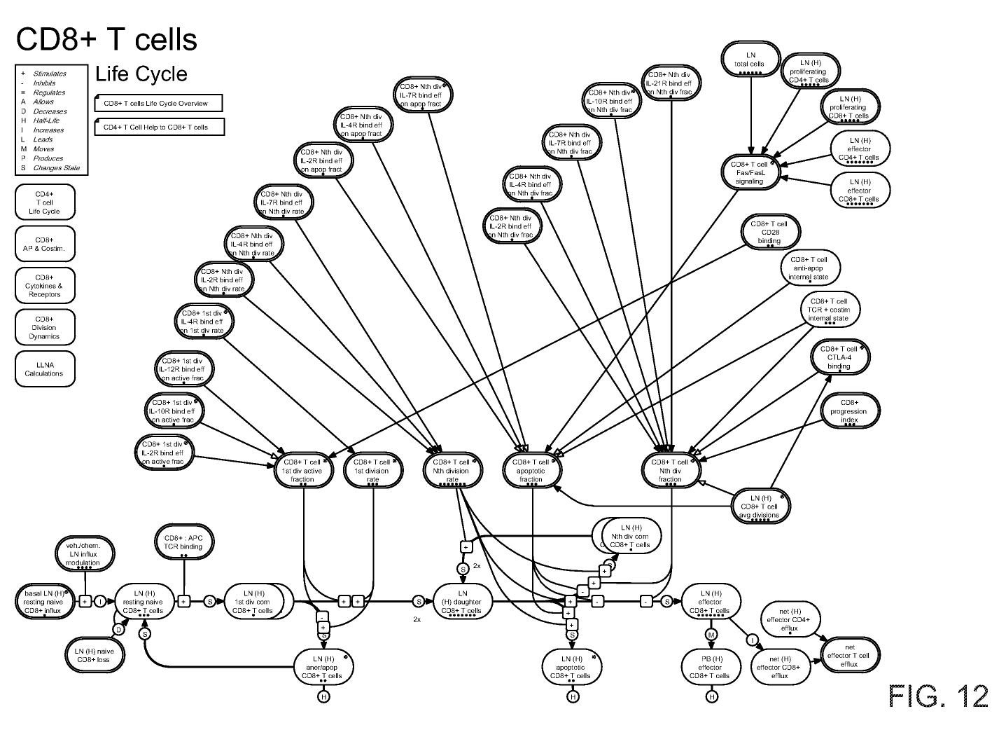

FIGS. 11 and 12 provide effect diagrams depicting the life cycle of CD4+ T cells and CD8+ T cells, respectively. The life cycle comprises proliferation of the T cells as well as interactions between the T cells and antigen presenting cells. In certain implementations, the first division of the T cell life cycle is regulated by a different subset of cytokines than subsequent divisions of the T cell life cycle. In a preferred implementation, the population of T cells comprises at least three classes of T cells selected from the group consisting of resting naïve T cells, daughter T cells, activated T cells, effector T cells, anergic T cells and apoptotic T cells.

In a preferred implementation, a subpopulation of the populations of T cells is selectively activated by the population of antigen presenting cells based on the expression of the plurality of costimulatory molecules. Exemplary costimulatory molecules include, but are not limited to, B7-1, B7-2, and anti-apoptotic molecules such as OX40L, 4-1BBL and CD70. Differential regulation of expression of these costimulatory molecules on antigen presenting cells in peripheral tissues will affect the extent of activation and the downstream processes of proliferation and differentiation of CD4+ and CD8+ T cells. Expression of each of the costimulatory molecules is responsive to concentrations of various cytokines in the milieu of the peripheral tissue, e.g., the epidermis. Once the antigen presenting cells transit to an immune site, such as the lymph node, the antigen presenting cells can interact with naïve T cells. The extent of interaction will be affected by the hapten being presented by the antigen presenting cell (APC), the MHC molecule that holds the hapten and the costimulatory molecules. Another feature of the costimulation process is the availability of space on the Langerhans cells for T cell occupation. Space is further affected by the likelihood of a T cell to want to revisit the APC for costimulation during the division process (progressive versus programmed implementation). All these factors combine to determine the activation of T cells.

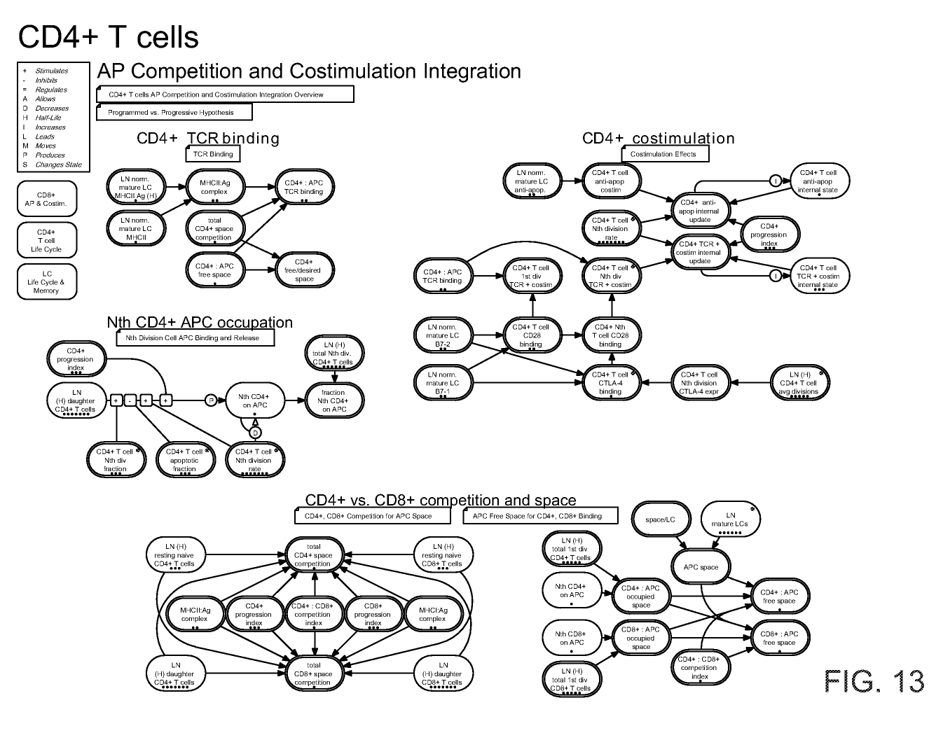

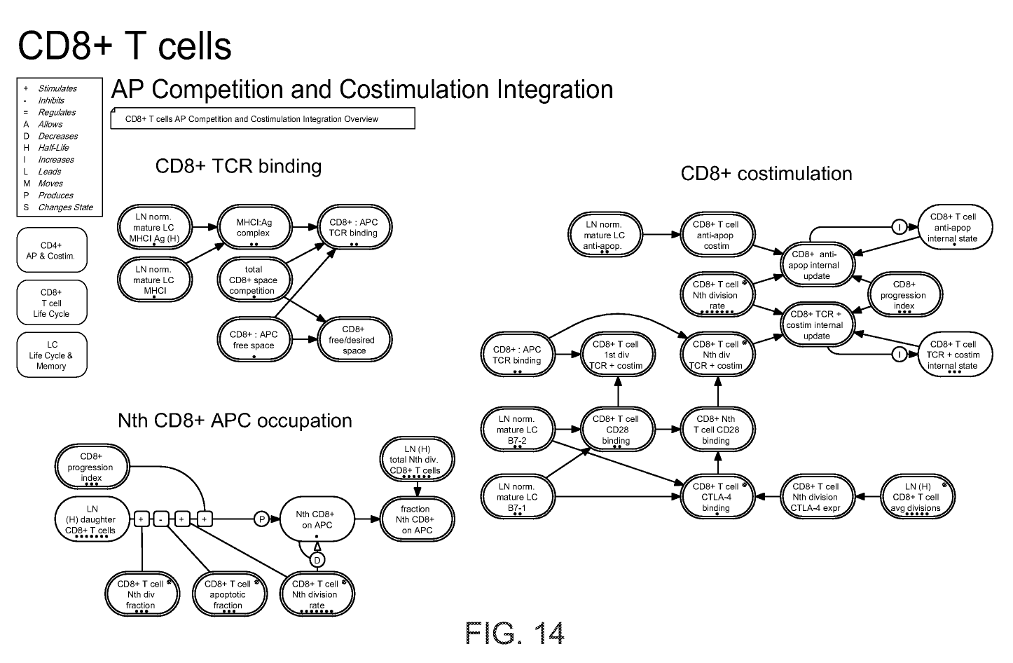

FIGS. 13 and 14 provide effect diagrams of the T cell stimulation module, in which costimulatory cells expressed by the antigen presenting cells influence the selective activation and proliferation of CD4+ or CD8+ T cells. Typically CD4+ T cells recognize antigen only when it is presented in the context of a MHC II molecule. Typically CD8+ T cells recognize antigen only when it is presented in the context of a MHC I molecule. In addition, the presence of certain costimulatory molecules, particularly B7-1 and/or B7-2 can influence the first and subsequent divisions of CD4+ and CD8+ T cells. Further, CD4+ and CD8+ T cell populations can compete for binding sites on the antigen presenting cells.

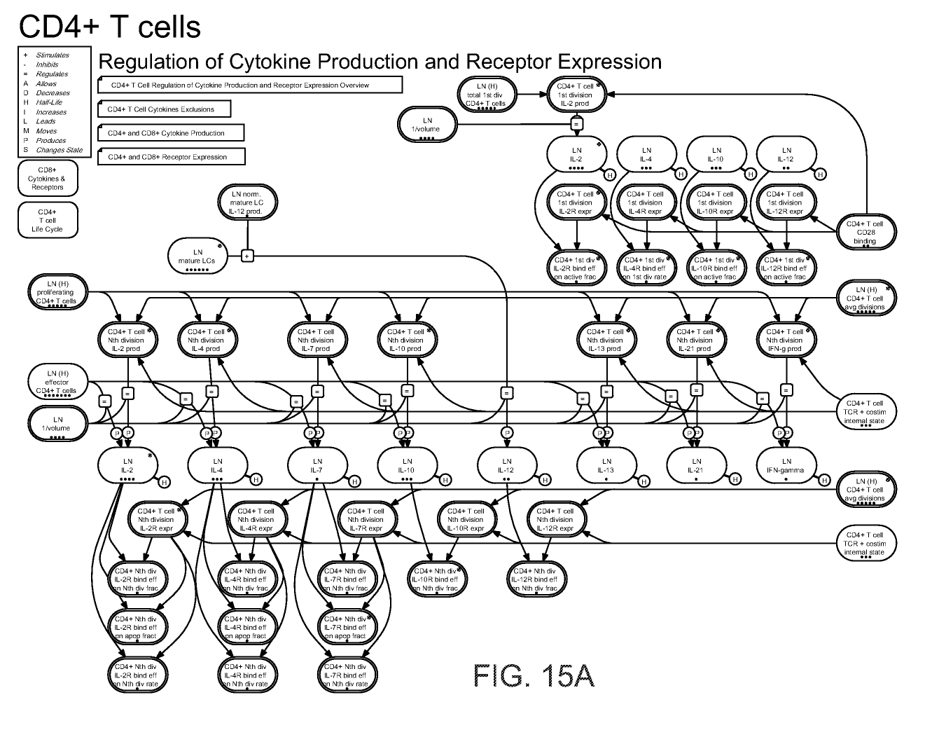

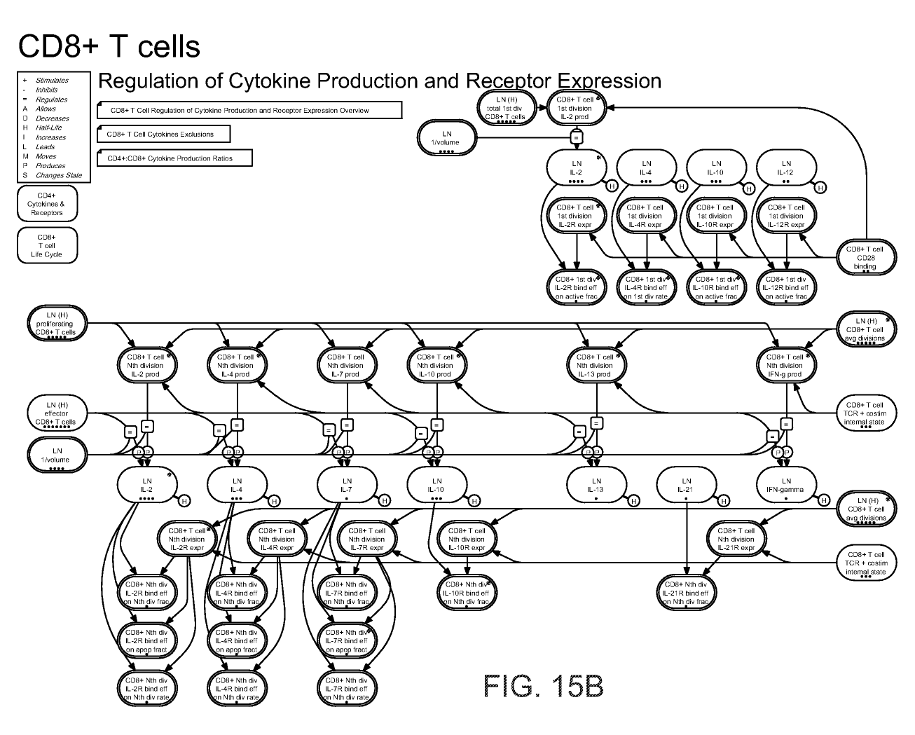

FIGS. 15A and 15B provide effect diagrams illustration the regulation of cytokine production and receptor expression by T cells.

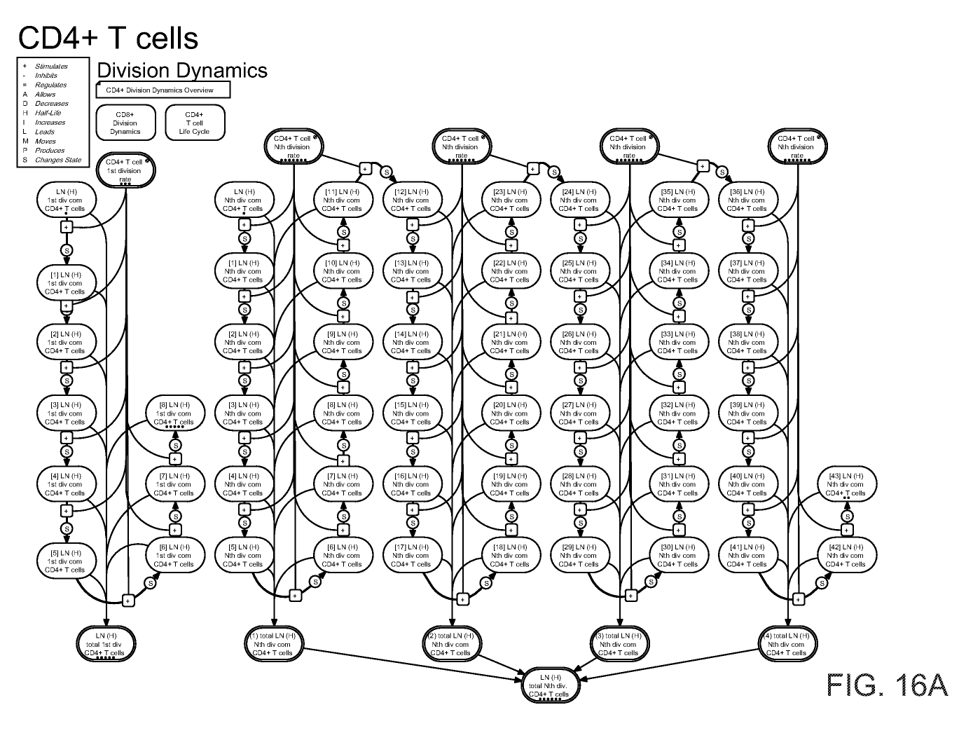

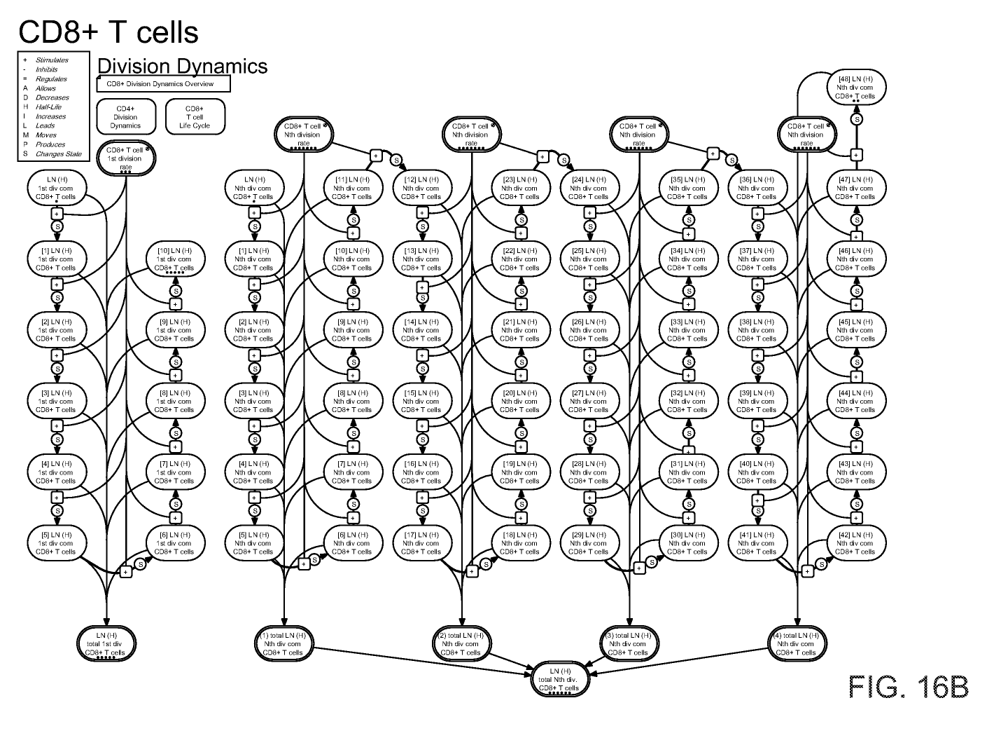

FIGS. 16A and 16B provide effect diagrams describing the division dynamics of the CD4+ and CD8+ T cell populations, respectively.

In a preferred implementation, the model comprises a determination of the average number of T cell divisions. T cell parallel architecture allows calculation of T cell average divisions. Many control points in the T cell architecture as well as cytokine production and CTLA-4 expression are dependent on the average number of cell divisions. The parallel architecture keeps track of how many cells would be in the model if there were no cell division. Comparison of this number with the total number of cells in the model allows continuous calculation of the average number of cell divisions, where

$${divisions}_{avg} = {log}_{2} \frac{{cells}_{total}}{{cells}_{precursor}}$$

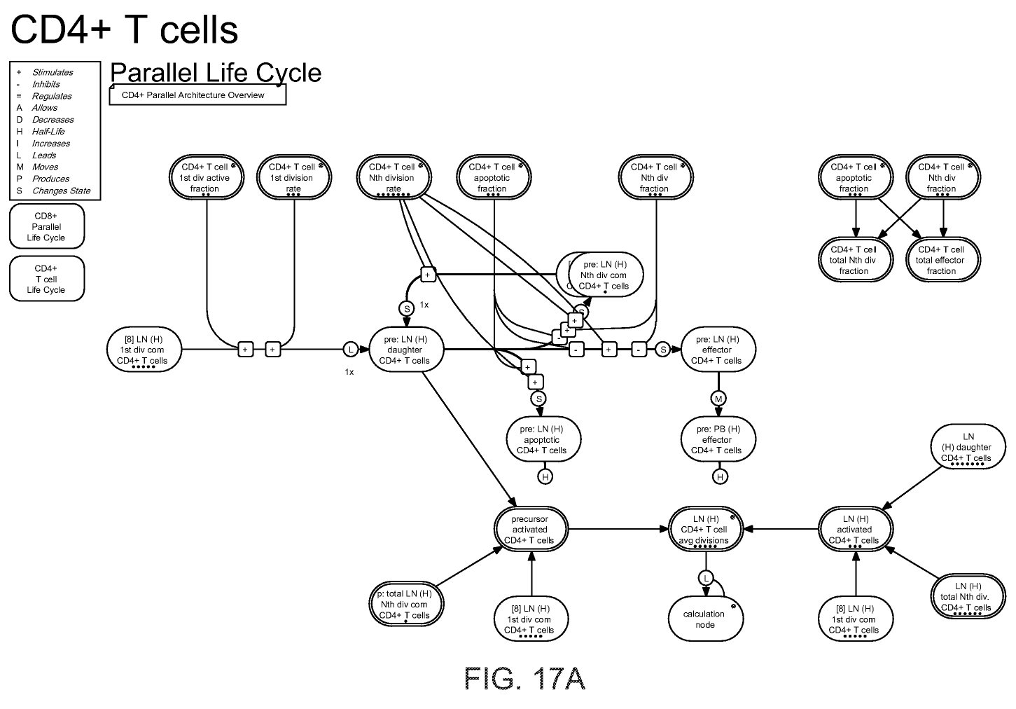

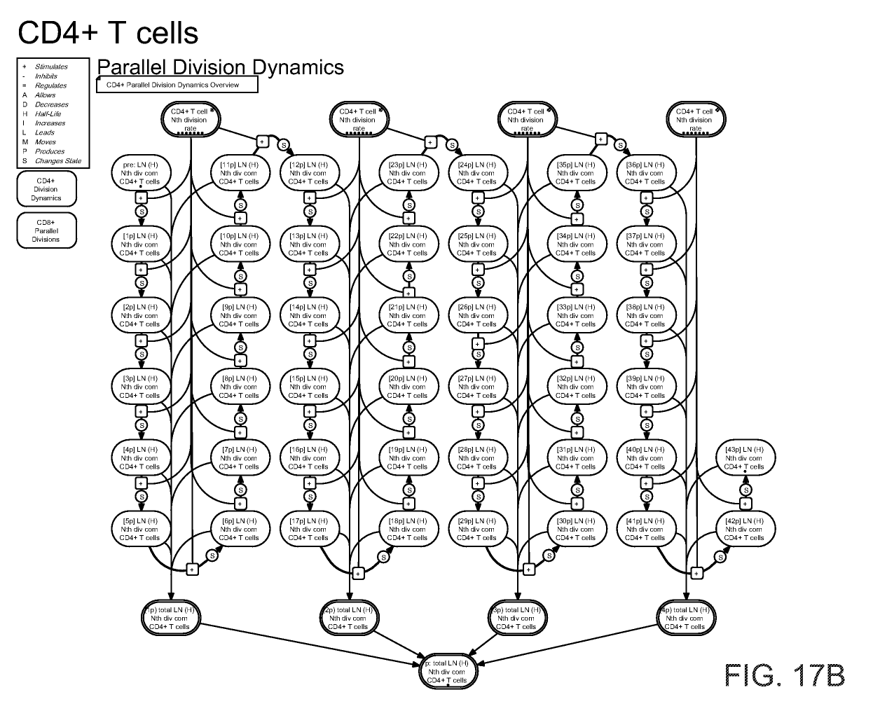

FIGS. 17A and 17B provide effect diagrams illustrating the parallel CD4+ T cell life cycle and division dynamics useful for calculating the average number of divisions of CD4+ T cells in the context of the computer models.

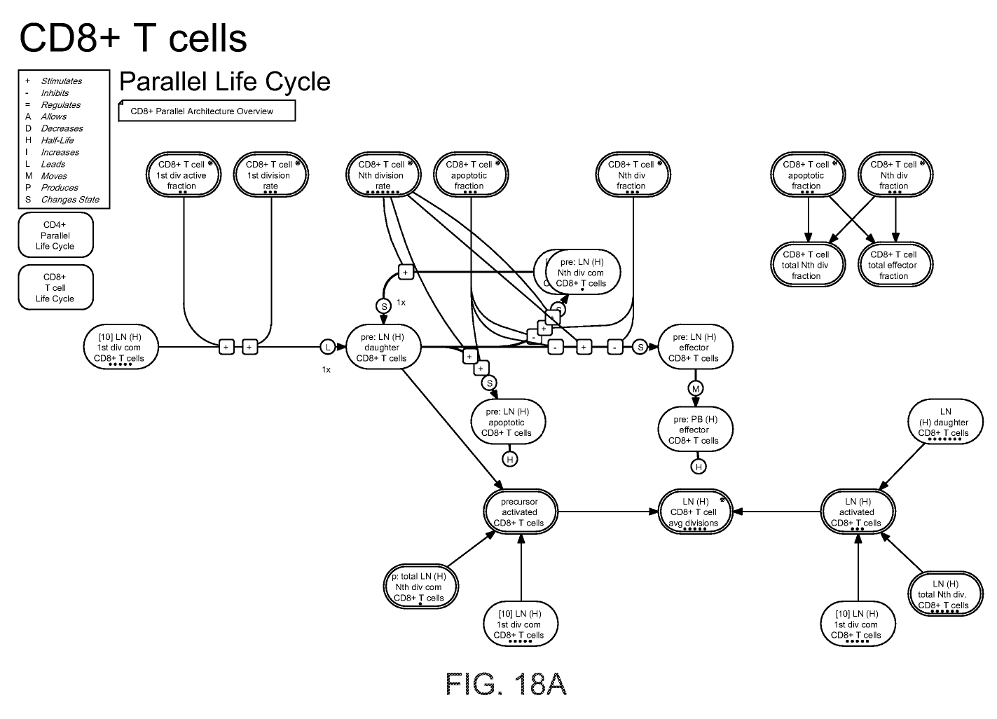

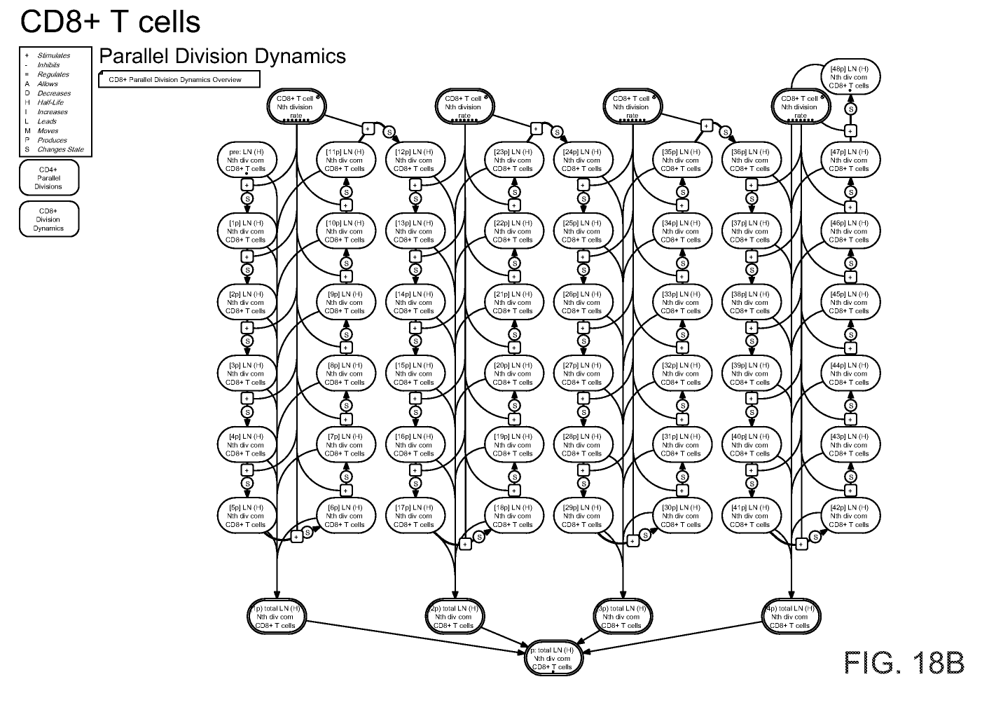

FIGS. 18A and 18B provide effect diagrams illustrating the parallel CD8+ T cell life cycle and division dynamics useful for calculating the average number of divisions of CD8+ T cells in the context of the computer models.

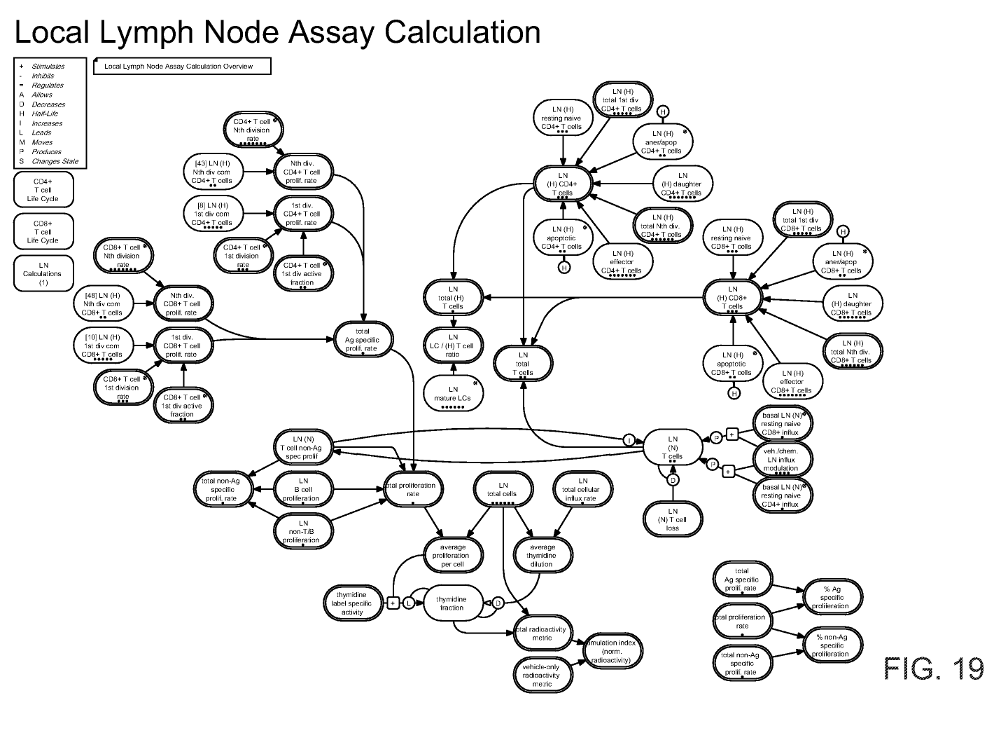

FIG. 19 provides an effect diagram describing a virtual local lymph node assay. In certain implementations, the computer model of skin sensitization will include a virtual local lymph node assay (LLNA). The model includes both a representation of cell proliferation in the lymph node as well as modeling the radioactive thymidine that would be used in an actual LLNA.

Certain implementations of the computer model can comprise a representation of B cells in the lymph node. Optionally, the model also can comprise a representation of recruitment of B cells into the lymph node. Influx of B cells to the lymph node is preferentially regulated by the presence of activated T cells in the lymph node. Although contact sensitivity is a phenomenon mediated by T cells, application of sensitizers induces a substantial (10-30%) increase in non-proliferating B cells in the lymph node. B cell recruitment plays a role in determining LLNA prediction and sensitization potential. Lymph node cellularity is influenced more significantly by B cell recruitment than B cell proliferation. This effect is more robust with strong sensitizers than moderate ones and does not occur after vehicle or irritant treatment.

One aspect of the invention is a stand alone computer model of antigen presentation comprising a) a costimulatory molecule regulation module comprising a representation of regulated expression of a plurality of costimulatory molecules by a population of antigen presenting cells in a first compartment, wherein the expression is regulated by a plurality of cytokines; b) a transit module comprising a representation of transit of the antigen presenting cells from the first compartment to a second compartment; and c) a T cell stimulation module comprising a representation of interaction between a population of antigen presenting cells and a population of T cells in the second compartment, whereby a subpopulation of the populations of T cells is selectively activated by the population of antigen presenting cells based on the expression of the plurality of costimulatory molecules. The costimulatory molecule regulation module is described in greater detail above, in conjunction with the discussion of FIG. 9. The transit module is described in detail above, in conjunction with the discussion of FIG. 8. The T cell stimulation module is described in detail above, in conjunction with the discussion of FIGS. 13 and 14. A computer model of the adaptive immune response can be found in U.S. Patent Publication No. 2003-0104475, entitled “Method And Apparatus For Computer Modeling Of An Adaptive Immune Response” and published 5 Jun. 2003. The computer models of described in this publication are similar to those of the present invention in that they describe transit of dendritic cells to a lymph node and subsequent activation of T cells. However, U.S. Patent Publication No. 2003-0104475 does not describe a costimulatory molecule regulation module, nor does this publication suggest that costimulatory molecules play a role in regulating antigen presentation and the subsequent activation of CD4+ or CD8+ T cells.

This invention can include a single computer model that serves a number of purposes. Alternatively, this invention can include a set of large-scale computer models covering a broad range of physiological systems. In addition to including a model of the skin sensitization, the system can include complementary computer models, such as, for example, epidemiological computer models. For use in healthcare, computer models can be designed to analyze a large number of subjects and chemicals. In some instances, the computer models can be used to create a large number of validated virtual patients and to simulate their responses to a large number of chemicals.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention also provides methods of simulating induction of skin sensitivity by a chemical, said method comprises executing a computer model of skin sensitization as described above. Methods of simulating induction of skin sensitization further can comprise applying a virtual protocol to the computer model to generate a set of outputs to represent a phenotype of the biological system. The phenotype can represent a normal state or an abnormal state. In certain implementations, the methods can further include accepting user input specifying one or more parameters or variables associated with one or more mathematical representations prior to executing the computer model. Preferably, the user input comprises a definition of a virtual patient or a definition of the virtual protocol.

Simulations utilizing the model of the invention can enable investigation of the role of cytokines in Langerhans cells activation and migration to the lymph node, evaluation of the relative importance of keratinocyte-derived versus Langerhans cell-derived cytokines, characterization of the impact of Langerhans cell maturation, cell contact and cytokine production on T cell activation and proliferation, investigation of the impact of Langerhans cell antigen loading and the ratio of Langerhans cells to T cells on T cell activation and proliferation and recommendation of immune cell-based in vitro assays to support the identification of sensitizers of varying potencies.

Running the computer model produces a set of outputs for a biological system represented by the computer model. The set of outputs can represent one or more phenotypes of the biological system, i.e., the simulated subject, and includes values or other indicia associated with variables and parameters at a particular time and for a particular execution scenario. For example, a phenotype is represented by values at a particular time. The behavior of the variables is simulated by, for example, numerical or analytical integration of one or more mathematical relations to produce values for the variables at various times and hence the evolution of the phenotype over time. The level of detail of the output can vary dependent upon the level of sophistication of the target user. Exemplary outputs can range from an exhaustive report including all parameters of the computer model to a simple yes/no response indicating induction (or not) of skin sensitivity by a chemical. In a preferred implementation, the set of outputs will comprise at least one of the total radioactivity metric, total cellularity, and antigen specific proliferation. However, the outputs are not limited to these three measures.

The computer executable software code numerically solves the mathematical equations of the model(s) under various simulated experimental conditions. Furthermore, the computer executable software code can facilitate visualization and manipulation of the model equations and their associated parameters to simulate different patients subject to a variety of stimuli. See, e.g., U.S. Pat. No. 6,078,739, entitled “Managing objects and parameter values associated with the objects within a simulation model,” the disclosure of which is incorporated herein by reference. Thus, the computer model(s) can be used to rapidly test hypotheses and investigate potential drug targets or therapeutic strategies.

In one implementation, the computer model can represent a normal state as well as an abnormal (e.g., an inflammatory) state of a biological system. For example, the computer model includes parameters that are altered to simulate an abnormal state or a progression towards the abnormal state. The parameter changes to represent an abnormal state are typically modifications of the underlying biological processes involved in the abnormal state, for example, to represent the genetic or environmental effects of a condition on the underlying physiology. By selecting and altering one or more parameters, a user modifies a normal state and induces a phenotype of interest. In one implementation, selecting or altering one or more parameters is performed automatically.

In the present implementation of the invention, various mathematical relations of the computer model, along with a modification defined by the virtual stimulus, can be solved numerically by a computer using standard algorithms to produce values of variables at one or more times based on the modification. Such values of the variables can, in turn, be used to produce the first set of results of the first set of virtual measurements. Typically, the virtual stimulus is a representation of application of a chemical to the skin.

One or more virtual patients in conjunction with the computer model can be created based on an initial virtual patient that is associated with initial parameter values. As used herein, the term virtual patient refers to a set of parameters for use in conjunction with the systems, apparatuses and methods of the present invention, the set of parameters represents an individual patient, a population of patients or an idealized patient or class of patients. The virtual patient, typically is a human but may represent any animal. A different virtual patient can be created based on the initial virtual patient by introducing a modification to the initial virtual patient. Such modification can include, for example, a parametric change (e.g., altering or specifying one or more initial parameter values), altering or specifying behavior of one or more variables, altering or specifying one or more functions representing interactions among variables, or a combination thereof. For instance, once the initial virtual patient is defined, other virtual patients, e.g., patients with hypersensitive skin, may be created based on the initial virtual patient by starting with the initial parameter values and altering one or more of the initial parameter values. Alternative parameter values can be defined as, for example, disclosed in U.S. Pat. No. 6,078,739. These alternative parameter values can be grouped into different sets of parameter values that can be used to define different virtual patients of the computer model. For certain applications, the initial virtual patient itself can be created based on another virtual patient (e.g., a different initial virtual patient) in a manner as discussed above.

In the context of one implementation of the invention, five exemplary virtual patients were developed. These first five virtual patients had primarily mouse-like physiological characteristics. The first virtual patient represents the archetypical normal patient. A second virtual patient represents a division-dominant sensitizer hypothesis, where the model includes fewer T cell clones, but greater T cell proliferation slightly favoring CD4+ expansion. The third virtual patient represents a diversity-dominant sensitizer hypothesis, wherein the model includes a greater number of T cell clones, but decreased proliferation relative to the archetypical normal patient. A fourth virtual patient represents a patient having reduced recruitment modulation, i.e. decreased recruitment of cells into the lymph node. The final virtual patient represents a subject in which CD4+ T cells are more progressive and CD8+ T cells are more programmed in response to chemical exposure.

Alternatively, or in conjunction, one or more virtual patients in the computer model can be created based on an initial virtual patient using linked simulation operations as, for example, disclosed in the following publication: “Method and Apparatus for Conducting Linked Simulation Operations Utilizing A Computer-Based System Model”, (U.S. Pat. No. 6,983,237). This publication discloses a method for performing additional simulation operations based on an initial simulation operation where, for example, a modification to the initial simulation operation at one or more times is introduced. In the present embodiment of the invention, such additional simulation operations can be used to create additional virtual patients in the computer model based on an initial virtual patient that is created using the initial simulation operation. In particular, a virtual patient can be customized to represent a particular subject. If desired, one or more simulation operations may be performed for a time sufficient to create one or more “stable” virtual patients of the computer model. Typically, a “stable” virtual patient is characterized by one or more variables under or substantially approaching equilibrium or steady-state condition.

Various virtual patients of the computer model can represent variations of the biological system that are sufficiently different to evaluate the effect of such variations on how the biological system responds to a given chemical. In particular, one or more biological processes represented by the computer model can be identified as playing a significant role in modulating biological response to the chemical, and various virtual patients can be defined to represent different modifications of the one or more biological processes. The identification of the one or more biological processes can be based on, for example, experimental or clinical data, scientific literature, results of a computer model, or a combination thereof. Once the one or more biological processes at issue have been identified, various virtual patients can be created by defining different modifications to one or more mathematical relations included in the computer model, where one or more mathematical relations represent the one or more biological processes. A modification to a mathematical relation can include, for example, a parametric change (e.g., altering or specifying one or more parameter values associated with the mathematical relation), altering or specifying behavior of one or more variables associated with the mathematical relation, altering or specifying one or more functions associated with the mathematical relation, or a combination of them. The computer model may be run based on a particular modification for a time sufficient to create a “stable” configuration of the computer model.

In certain implementations, the model of the induction of skin sensitivity is executed while applying a virtual stimulus or protocol representing, e.g., exposure to an allergen or administration of a drug. A virtual stimulus can be associated with a stimulus or perturbation that can be applied to a biological system. Different virtual stimuli can be associated with stimuli that differ in some manner from one another. Stimuli that can be applied to a biological system can include, for example, existing or hypothesized therapeutic agents, treatment regimens, and medical tests. Additional examples of stimuli include exposure to chemical agents. Further examples of stimuli include environmental changes such as those relating to changes in level of exposure to an environmental agent.

A virtual protocol, e.g., a virtual therapy, representing an actual therapy can be applied to a virtual patient in an attempt to predict how a real-world equivalent of the virtual patient would respond to the therapy. Virtual protocols that can be applied to a biological system can include, for example, existing or hypothesized therapeutic agents and treatment regimens, mere passage of time, exposure to environmental toxins, increased exercise and the like. By applying a virtual protocol to a virtual patient, a set of results of the virtual protocol can be produced, which can be indicative of various effects of a therapy.

In certain implementations, the invention provides methods of predicting induction of skin sensitivity by a chemical, comprising creating a computer model of induction of skin sensitivity; executing the computer model to identify a set of biological processes contributing to the induction of skin sensitivity; identifying a set of biological assays that would be relevant to identifying sensitizers vs. non-sensitizers based on the set of biological processes; testing a chemical in one or more biological assays of the set of biological assays to generate a set of test results; and predicting induction of skin sensitivity based on data comprising the set of test results.

In some instances, identifying critical biological processes can include sensitivity analysis. Sensitivity analysis can involve prioritization of biological processes that are related to the induction of skin sensitivity. In some instances, sensitivity analysis can involve a rank ordering of biological processes based on their degree of connection to a chemical-induced response. Exemplary chemical-induced responses include, but are not limited to, chemical exposure, epidermal activation/irritation, lymph node nonspecific responses, lymph node antigen presentation and lymph node antigen-specific responses. Sensitivity analysis allows a user to determine the importance of a biological process in the context of the biological system as a whole. An example of a biological process of greater importance is a biological process that increases the severity of the skin sensitivity or the rate at which the sensitivity is induced. Thus, identifying qualities of a chemical that enhance or exacerbate the biological process can allow one to identify the chemical as likely inducing chemical sensitivity. In a rank ordering, a biological process that plays a more important role in the induction of skin sensitivity typically gets a higher rank. The rank ordering can also be done in a reverse manner, such that a biological process that plays a more important role gets a lower rank. Typically, biological processes that are identified as playing a more important role can be identified as critical biological processes.

The sensitivity analysis confirmed that binding efficiency and other exposure-related properties determine the effective antigen dose and therefore response. In addition, epidermal activation pathways including cytokine production, particularly of TNF-α, are major drivers of antigen-specific proliferation, due to influence on LC maturation and migration. The stimulation index (and total radioactivity metric) of a local lymph node assay reflects both antigen-specific sensitization and nonspecific cellular proliferation in the lymph node. The relative contribution of each depends on the sensitizer strength. The number of antigen-specific T cells reactive to chemical-derived antigens affects the magnitude of the sensitization response. Finally, non-antigen-specific pathways including LC maturation and migration and increased nonspecific lymphocyte recruitment to the LN enable and amplify the sensitization response

It is clear that the degree of antigenicity and number of reactive T cell cones are major drivers of skin sensitization in response to chemical exposure. However, these are very difficult quantities to measure, and development of assays for these chemical properties may not be possible. It is important, therefore, to identify other assayable pathways that are consistently sensitive, regardless of a chemical's antigenicity and number of reactive T cell clones. Methods for identifying critical processes are described in greater detail in U.S. Patent Publication No. 2005-0130192, entitled “Apparatus And Method For Identifying Therapeutic Targets Using A Computer Model” and published 16 Jun. 2005. The identification of biological assays based on biological processes identified by execution of a computer model is discussed in greater detail in U.S. Patent Publication No. 2004-0254736, entitled “Predictive Toxicology for Biological Systems” and published 16 Dec. 2004, incorporated herein by reference.

For certain applications, a virtual protocol can be created, for example, by defining a modification to one or more mathematical relations included in a model, which one or more mathematical relations can represent one or more biological processes affected by a condition or effect associated with the virtual protocol. A virtual protocol can define a modification that is to be introduced statically, dynamically, or a combination thereof, depending on the particular conditions and/or effects associated with the virtual protocol.

### IV. EXAMPLES

### A. Method for Developing a Computer Model of Antigen Presentation

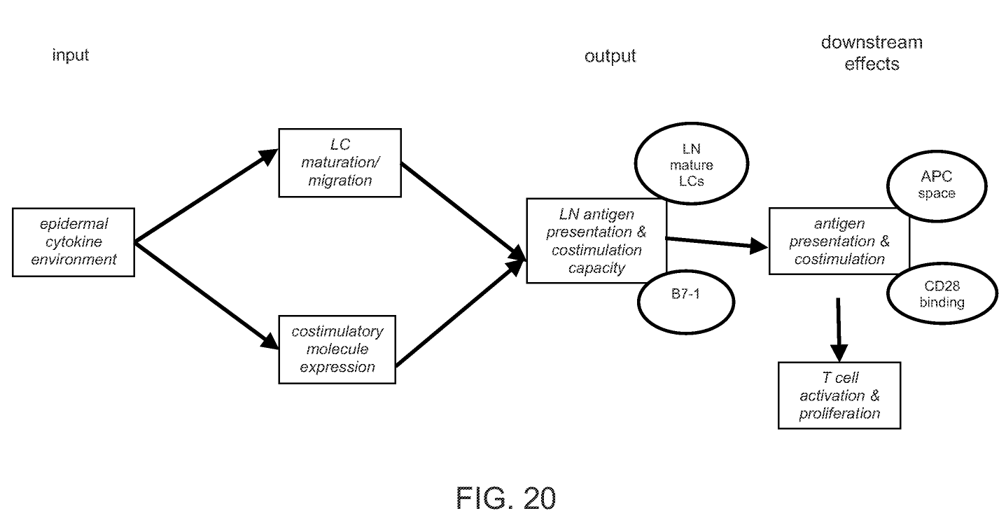

The key equations that define the models described herein are those that calculate the net antigen presentation and costimulation capacity of antigen presenting cells. In this example, this antigen presentation and costimulation capacity is a function of the cytokine milieu in the epidermal compartment, and the antigen presenting cells are Langerhans cells (LCs). Antigen presentation & costimulation capacity is a product of both the total LC population and migratory capacity as well as the expression of costimulatory molecules on these LCs. This antigen presentation and costimulation capacity can then be used to determine the efficacy of T cell activation in the lymph node (LN) compartment and subsequent T cell clonal expansion (process depicted in FIG. 20).

In this model, the cytokine environment in the epidermis is comprised of GM-CSF, IFN-γ, IL-1α, IL-1β, IL-4, IL-8, IL-10, IL-18, PGE-2, and TNF-α (see FIG. 4). These cytokines regulate the expression of maturation, migration, and costimulatory markers on the LCs through various mechanisms of stimulation, potentiation, and inhibition (see FIG. 9). For example, six of the above ten cytokines influence the potential of an LC to mature and migrate to the lymph nodes (see LC life cycle/migration highlight). Similarly, a subset of the above cytokines affects costimulatory molecule expression on these LCs (see costimulatory molecule expression highlight). The more that LCs are induced to mature and migrate, the greater the population of LN mature LCs to present antigen to T cells in the LN. Similarly, the greater the capacity for upregulation of B7-1 costimulatory molecule, for example, the more likely B7-1 is to appear on a mature LC in the LN (FIG. 8). Using this information passed from the epidermis, antigen presentation is integrated in various ways (FIG. 13). One key aspect of this antigen presentation process is described as an example. The number of LN mature LCs provides a greater capacity on the LCs for T cells to attach and become stimulated. This directly adds to the free space available for TCR binding. Similarly, the more B7-1 is upregulated, the greater the chance for CD28 binding and effective costimulation. Downstream, CD28 binding plays a direct role in the activation and continued proliferation of T cells.

As an example, we present the equations used to derive the number of LCs migrating to the LN from the epidermis after exposure to epidermal cytokines. An explanation of the variables used in the equations is shown below:

Variables
LC_{EII}=population of epidermal inducible immature LCs
LC_{E}=population of epidermal maturing LCs
LC_{D}=population of dermal maturing LCs
LC_{Ly}=population of lymphatic maturing LCs
LC_{LN}=population of LN mature LCs
LC_{A}=population of LN apoptosed LCs
induction_{LC}=rate of epidermal LC mat/mig induction
migₑ_{_{—}}ₜₒ_{_{—}}_{d}=rate of migration of LCs from epidermis to dermis
mig_{d}_{_{—}}ₜₒₗ=rate of migration of LCs from dermis to lymphatics
migₗ_{_{—}}ₜₒ_{_{—}}_{LN}=rate of migration of LCs from lymphatics to LN
mig_{LN}_{_{—}}ₜₒ_{_{—}}ₐ=rate of change of mature LCs to apoptosed LCs

The derivation for the population of mature LCs is shown below:

$$\frac{d {LC}_{E}}{d t} = {induction}_{LC} {LC}_{eii} - {mig}_{e\_to \_d} {LC}_{E}$$

$$\frac{d {LC}_{D}}{d t} = {mig}_{e\_to \_d} {LC}_{E} - {mig}_{d \_to \_l} {LC}_{D}$$

$$\frac{d {LC}_{Ly}}{d t} = {mig}_{d \_to \_l} {LC}_{D} - {mig}_{l \_to \_LN} {LC}_{Ly}$$

$$\frac{d {LC}_{LN}}{d t} = {mig}_{l \_to \_LN} {LC}_{Ly} - {mig}_{LN \_to \_a} {LC}_{LN}$$

Here, cytokines in the epidermis directly affect induction_{LC} and determine the rate at which epidermal inducible immature LCs become mature and migrate. The derivation of induction_{LC} is as described above, in that several elements of the cytokine environment enable LC maturation and migration (see arrows feeding in to the LC mat/mig induction function node). For this example, the relevant cytokines are IL-18, TNF-α, IL-1, IL-10, PGE2, and IFN-γ. There is also an additional effect of apoptotic/necrotic keratinocytes on upregulation of the maturation and migration markers. The integration of the listed cytokines and keratinocytes influence the maturation and migration process in a logistic manner as described by Michaelis-Menten dynamics, described elsewhere within this document.

Variables

KCₐₚₒₚ=population of apoptotic and necrotic keratinocytes

IL-18=concentration of IL-18 in the epidermis

TNF-α=concentration of TNF-α in the epidermis

IL-1=concentration of IL-1 in the epidermis

IL-10=concentration of IL-10 in the epidermis

PGE2=concentration of PGE2 in the epidermis

IFN-γ=concentration of IFN-γ in the epidermis

induction_{LC}=rate of LC maturation and migration induction

Indices:

i=cytokine or KCₐₚₒₚ

Parameters
bl=baseline value of rate of maturation and migration induction
Vₘₐₓᵢ=maximum rate of LC maturation and migration induction reached at high concentrations of cytokine i or large population of KCₐₚₒₚ
Kᵢ=the dose at which half the maximal Vₘₐₓᵢ for i is achieved
nᵢ=the Hill coefficient, describing the steepness of the sigmoidal dose response for i

The derivation for the rate of LC maturation and migration induction is as follows:

$${induction}_{LC} = ( \begin{matrix}bl + \frac{{{V}_{max IL - 18} [ IL - 18 ]}^{{n}_{IL - 18}}}{{K}_{IL - 18}^{{n}_{IL - 18}} + {[ IL - 18 ]}^{{n}_{IL - 18}}} + \\ \frac{{{V}_{max IL - 1} [ IL - 1 ]}^{{n}_{IL - 1}}}{{K}_{IL - 1}^{{n}_{IL - 1}} + {[ IL - 1 ]}^{{n}_{IL - 1}}} ⋆ \\ \frac{{{V}_{max TNF - α} [ TNF - α ]}^{{n}_{TNF - α}}}{{K}_{TNF - α}^{{n}_{TNF - α}} + {[ TNF - α ]}^{{n}_{TNF - α}}} ⋆ \\ \frac{{{V}_{max IL - 18} [ IL - 18 ]}^{{n}_{IL - 18}}}{{K}_{IL - 18}^{{n}_{IL - 18}} + {[ IL - 18 ]}^{{n}_{IL - 18}}} + \\ \frac{{{V}_{max PGE 2} [ PGE 2 ]}^{{n}_{PGE 2}}}{{K}_{PGE 2}^{{n}_{PGE 2}} + {[ PGE 2 ]}^{{n}_{PGE 2}}} + \\ \frac{{{V}_{max {KC}_{apop}} [ {KC}_{apop} ]}^{{n}_{KCapop}}}{{K}_{{KC}_{apop}}^{{n}_{KCapop}} + {[ {KC}_{apop} ]}^{{n}_{KCapop}}} + \\ \frac{{{V}_{max IFN - γ} [ IFN - γ ]}^{{n}_{IFN - γ}}}{{K}_{IFN - λ}^{{n}_{IFN - γ}} + {[ IFN - γ ]}^{{n}_{IFN - γ}}}\end{matrix} ) ⋆ ( 1 - \frac{{{V}_{max IL - 10} [ IL - 1 ]}^{{n}_{IL - 10}}}{{K}_{IL - 10}^{{n}_{IL - 10}} + {[ IL - 10 ]}^{{n}_{IL - 10}}} )$$

With this representation, IL-18, PGE2, apoptotic and necrotic keratinocytes, and IFN-γ are stimulators, IL-1, TNF-α, and IL-18 potentiate one another's effects, and IL-10 acts as an inhibitory cytokine down regulating the rate of LC maturation and migration induction.

### B. Computer Simulation of Weakly, Moderately and Strongly Sensitizing Chemical

Three prototypical chemicals were defined to capture 3 chemical categories, specifically (1) strong sensitizers (e.g., DNCB, oxazalone, hydroquinone), (2) moderate sensitizers (e.g., cinnamic aldehyde, hexyl cinnamic aldehyde, isoeugenol), and (3) non-sensitizers (e.g., SLS, glycerol, PABA, Tween 80). Data available in the public domain were analyzed to determine the high-level characteristics defining these chemical groups. The data on dose responses for stimulation index (SI) for chemicals in each class were fit to a sigmoidal curve as described by the Michaelis-Menten (or logistic-type) equation of the form:

$$SI = {V}_{min} + ( {V}_{max} - {V}_{min} ) \frac{{[ chemical ]}^{n}}{{K}_{m}^{n} + {[ chemical ]}^{n}}$$

in which:
[chemical] represents the applied chemical dose (in %)
Vₘᵢₙ represents the SI at 0% dose (vehicle only), which by definition has the value 1,
Vₘₐₓ represents the saturating value of SI reached at high doses,
n, the Hill coefficient, describes the steepness of the sigmoidal dose response, and
Kₘ, often termed the EC50, is the dose at which half the maximal SI value (Vₘₐₓ) is achieved.

The analysis revealed the following patterns:
Strong sensitizers are characterized by Vₘₐₓ>20, Kₘ<1%
Moderate sensitizers are characterized by 10<Vₘₐₓ<20, Kₘ>1%
Weak/non-sensitizers are characterized by Vₘₐₓ<10, Kₘ>1%
   These patterns were recapitulated in the three prototypical chemicals.

The prototypical chemicals were created by varying the chemical antigenicity and the number of CD4+ and CD8+ T cell clones responding to chemical-associated antigens. The antigenicity parameter represents the relative propensity of a chemical, once taken up by an antigen-presenting cell, to be processed and presented as epitopes and stimulate a T cell response. This property determines the dose-response relationship between amount of chemical acquired and the resulting amount of T cell antigen recognition via TCR-binding, and is influenced by variables such as processing and presentation efficiency and TCR affinity. The number of CD4+ and CD8+ T cells clones responding to a particular chemical's antigens is a measure of the promiscuity of chemical. The model assumes an underlying clonal frequency of 10⁻⁵, i.e., 1 in 10,000 T cells is specific for each epitope. The number of reactive clones multiplies this clonal frequency. Thus, if a chemical's antigens are capable of activating 300 different T cell clones, the total percentage of T cells reactive to the chemical is 300×1/10,000=0.3%.

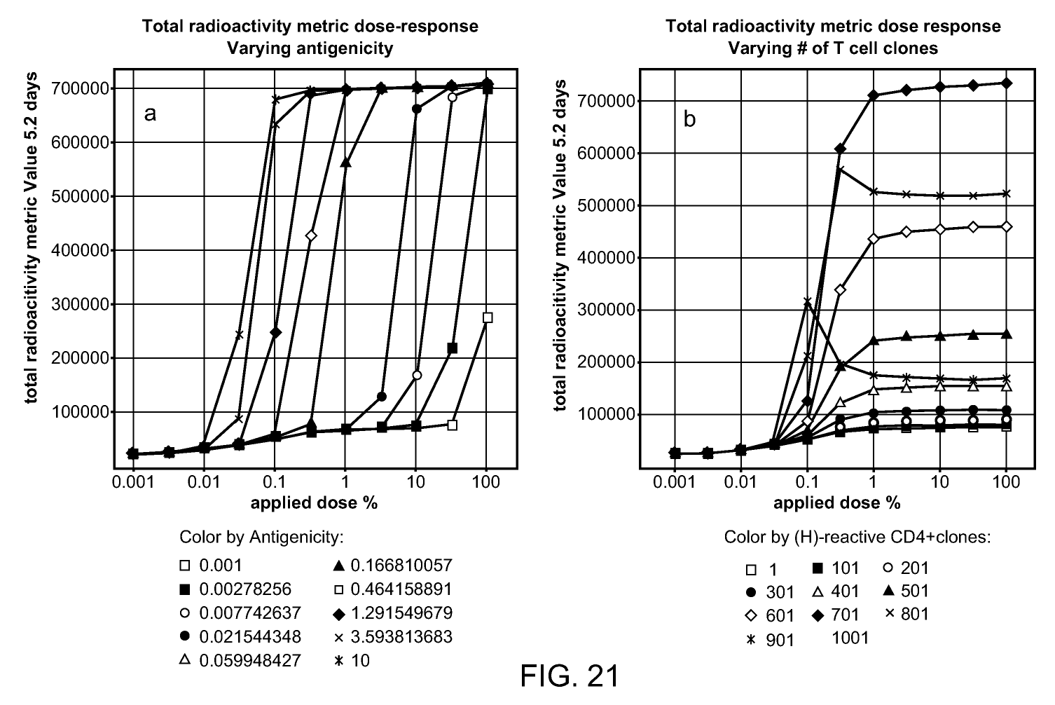

The Kₘ of the virtual dose response was found to be inversely related to the antigenicity (FIG. 21a), whereas the Vₘₐₓ is directly related to the number of clones (FIG. 21b). Note that at very high clone numbers, the relationship between clone number and responsiveness reverses to a negative relationship with increasing dose. This is due to multiple effects. At very high clone numbers, too many naïve cells compete for space on the LCs, reducing subsequent proliferation steps. Additionally, high clone numbers may accelerate the overall sensitization response leading to an earlier peak and thus a lower SI value at the assayed time. Thus, the strategy for creation of the prototypical chemicals takes advantage of the strong dependence of the sensitization response on the chemical's antigenicity and number of clones.

The calibrated and validated representation of the virtual DNCB chemical was used for the prototypical strong sensitizer. To create the moderate and weak/non-sensitizer, the antigenicity and clone number were adjusted to meet the characteristic SI dose-response patterns identified above, so that Vmax increases with increasing chemical strength and Km decreases with increasing chemical strength. The resulting parameter specifications for each prototypical chemical are listed in Table 1.

TABLE 1
Antigenicity and clone number specifications
for the 3 prototypical chemicals.

| | non/weak- | moderate | strong |
|---|---|---|---|
| | sensitizer | sensitizer | sensitizer |
| antigenicity | 0.02 | 0.14 | 1 |
| clones | 20 | 77 | 300 |

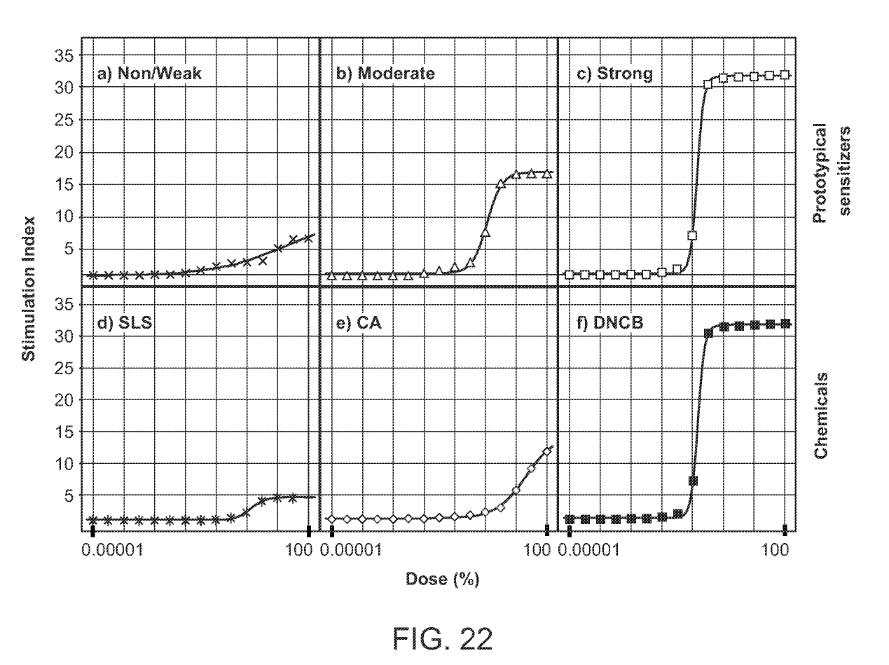

The resulting dose response for each prototypical chemical is shown in FIG. 22 along with the validated model implementation of a chemical from the same class, for comparison. Note that the prototypical non/weak-sensitizer is effectively a non-sensitizer over most of the dose response range (certainly up to 1%), becoming a weak sensitizer only at very high doses.

Various modifications and variations of the described computer models, methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A computer model of chemical sensitivity of skin comprising:
a) a computer-readable memory storing code to define
i) an epidermal compartment comprising
1) a mathematical representation of exposure of an epidermal tissue to a chemical, and
2) a mathematical representation of a first population of antigen presenting cells interacting with the chemical; and
i) a lymph node compartment comprising
1) a mathematical representation of a second population of antigen presenting cells; and
2) a mathematical representation of a population of T cells, wherein at least a subpopulation of the population of T cells interacts with the second population of antigen presenting cells; and
b) a processor coupled to the computer-readable memory, the processor configured to process the code producing a simulated biological characteristic and to store the simulated biological characteristic in a computer-readable medium.

2. The computer model of claim 1, wherein the first population of antigen presenting cells comprises a population of Langerhans cells.

3. The computer model of claim 1, wherein the second population of antigen presenting cells comprises a population of Langerhans cells.

4. The computer model of claim 1, wherein the code further defines a mathematical representation of transit of antigen presenting cells from the epidermal compartment to the lymph node compartment.

5. The computer model of claim 1, wherein the epidermal compartment further comprises a representation of a plurality of cytokines in the epidermal tissue.

6. The computer model of claim 5, wherein the plurality of cytokines comprises at least one cytokine selected from the group consisting of IL-1α, IL-1β, IL-4, IL-8, IL-10, IL-18, TNF-α, GM-CSF, IFN-γ, and PGE2.

7. The computer model of claim 1, wherein the interaction between the chemical and the population of antigen presenting cells comprises uptake of the chemical by cells within the population.

8. The computer model of claim 7, wherein the interaction between the chemical and the population of antigen presenting cells further comprises processing of the chemical as a hapten.

9. The computer model of claim 8, wherein the second population of antigen presenting cells comprises antigen presenting cells which were exposed to the chemical in the epidermal compartment and subsequently transited to the lymph node compartment.

10. The computer model of claim 8, wherein the second population of antigen presenting cells express costimulatory molecules based upon cytokines present in the epidermal compartment.

11. The computer model of claim 1, wherein the population of T cells comprises CD4+ and CD8+ T cells.

12. The computer model of claim 1, wherein the population of T cells comprises at least three classes of T cells selected from the group consisting of resting naïve T cells, daughter T cells, activated T cells, effector T cells, anergic T cells and apoptotic T cells.

13. The computer model of claim 1, wherein the code further defines a virtual patient.

14. The computer model of claim 13, wherein the virtual patient represents an animal.

15. The computer model of claim 14, wherein the animal is a human.

16. The computer model of claim 13, wherein the code defines a plurality of virtual patients.

17. A system for predicting sensitivity of skin of a subject to a chemical comprising:
a) a computer-executable data editor, capable of accepting biological data relating to the chemical;
b) a computer-executable integrator, capable of executing a computer model of skin sensitization with the biological data to generate a prediction of the sensitivity of the skin of the subject, wherein the computer model comprises
i) an epidermal compartment comprising
1) a representation of exposure of an epidermal tissue to a chemical, and
2) a representation of a first population of antigen presenting cells interacting with the chemical; and
ii) a lymph node compartment comprising
1) a representation of a second population of antigen presenting cells; and
2) a representation of a population of T cells, wherein at least a subpopulation of the population of T cells interacts with the second population of antigen presenting cells.
c) a computer-executable report generator capable of reporting the predicted sensitivity of the skin of the subject to the chemical.

18. The system of claim 17, wherein the computer-executable data editor further is capable of accepting a set of parameters describing a virtual patient.

19. The system of claim 18, wherein the computer-executable integrator further is capable of executing the computer model with the set of parameters describing the subject.

20. A method of predicting induction of skin sensitivity by a chemical, comprising
creating a computer model of induction of skin sensitivity;
executing the computer model to identify a set of biological processes contributing to the induction of skin sensitivity;
identifying a set of biological assays that would be relevant to identifying sensitizers vs. non-sensitizers based on the set of biological processes;
testing a chemical in one or more biological assays of the set of biological assays to generate a set of test results; and
predicting induction of skin sensitivity based on data comprising the set of test results.

21. The method of claim 20, wherein predicting induction of skin sensitivity comprises executing the computer model with data comprising the set of test results.

22. The method of claim 20, wherein creating a model of induction of skin sensitivity comprises:
identifying one or more biological processes associated with chemical exposure in the epidermis one or more biological processes associated with a first population of antigen presenting cells in an epidermal compartment;
identifying one or more biological processes associated with a population of T cells and one or more biological processes associated with a second population of antigen presenting cells in a lymph node compartment;
mathematically representing each biological process to generate one or more representations of a biological process associated with the epidermal compartment and one or more representations of a biological process associated with the lymph node compartment; and
combining the representations of biological processes to form a computer model of skin sensitization.

23. A system comprising:
a) a processor including computer-readable instructions stored thereon that, upon execution by a processor, cause the processor to simulate induction of skin sensitivity, the computer readable instructions comprising:
i) mathematically representing one or more biological processes associated with exposure of a chemical to an antigen presenting cell in an epidermal compartment;
ii) mathematically representing one or more biological processes associated with antigen presentation and/or T cell activation in a lymph node compartment;
iii) defining a set of mathematical relationships between the representations of biological processes associated with the epidermal compartment and representations of biological processes associated with the lymph node compartment; and
iv) applying a virtual protocol to the set of mathematical relationships to generate a set of outputs;
b) a first user terminal, the first user terminal operable to receive a user input specifying one or more parameters associated with one or more mathematical representations defined by the computer readable instructions; and
c) a second user terminal, the second user terminal operable to provide the set of outputs to a second user.

24. A computer model of antigen presentation comprising:
a) a computer-readable memory storing code to define
i) a costimulatory molecule regulation module comprising a representation of regulated expression of a plurality of costimulatory molecules by a population of antigen presenting cells in a first compartment, wherein the expression is regulated by a plurality of cytokines;
ii) a transit module comprising a representation of transit of the antigen presenting cells from the first compartment to a second compartment; and
iii) a T cell stimulation module comprising a representation of interaction between a population of antigen presenting cells and a population of T cells in the second compartment, whereby a subpopulation of the populations of T cells is selectively activated by the population of antigen presenting cells based on the expression of the plurality of costimulatory molecules; and
b) a processor coupled to the computer-readable memory, the processor configured to process the code producing a simulated biological characteristic and to store the simulated biological characteristic in a computer-readable medium.

25. The computer model of claim 24, wherein the plurality of cytokines comprises at least one cytokine selected from the group consisting of IL-1α, IL-1β, IL-4, IL-8, IL-10, IL-18, TNF-α, GM-CSF, IFN-γ and PGE2.

26. The computer model of claim 25, wherein the plurality of cytokines comprises IL-1α, IL-1β, IL-4, IL-8, IL-10, IL-18, TNF-α, GM-CSF, IFN-γ and PGE2.

27. The computer model of claim 24, wherein the population of antigen presenting cells is a population of dendritic cells.

28. The computer model of claim 27, wherein the population of dendritic cells is a population of Langerhans cells.

29. The computer model of claim 24, wherein the subpopulation of T cells is further activated by a plurality of cytokines expressed in the lymph node.

30. The computer model of claim 29, wherein the plurality of costimulatory molecules comprises a molecule selected from the group consisting of MHC I, MHC II, B7-1, B7-2, an anti-apoptotic molecule and IL-12.

31. The computer model of claim 24, wherein the plurality of cytokines regulate costimulatory molecule expression when the population of antigen presenting cells uptake an antigen.

32. The computer model of claim 24, wherein the first compartment is a peripheral tissue and the second compartment is a lymph node.

33. The computer model of claim 32, wherein the peripheral tissue is epidermal tissue.

34. The computer model of claim 24, wherein the subpopulation of T cells is a population of CD8+ T cells.

35. The computer model of claim 34, wherein the population of CD8+ T cells is selectively activated by expression of cytokines and costimulatory molecules.

36. The computer model of claim 24, wherein the subpopulation of T cells is a population of CD4+ T cells.

37. The computer model of claim 36, wherein the population of CD4+ T cells is selectively activated by expression of cytokines and costimulatory molecules.
